(19) United States
(12) Patent Application Publication
(10) Pub. No.: US 2023/0164645 A1
(43) Pub. Date: May 25, 2023

(54) HANDOVER METHOD AND APPARATUS, AND COMMUNICATIONS DEVICE

(71) Applicant: VIVO MOBILE COMMUNICATION CO., LTD., Dongguan (CN)

(72) Inventors: Yanxia ZHANG, Dongguan (CN); Zhenhua XIE, Dongguan (CN)

(73) Assignee: VIVO MOBILE COMMUNICATION CO., LTD., Dongguan (CN)

(21) Appl. No.: 18/095,504

(22) Filed: Jan. 10, 2023

Related U.S. Application Data
(63) Continuation of application No. PCT/CN2021/109828, filed on Jul. 30, 2021.

(30) Foreign Application Priority Data
Jul. 31, 2020 (CN) 202010763645.6

(51) Int. Cl. H04W 36/00; H04W 36/08

(52) U.S. Cl. CPC H04W 36/0055; H04W 36/08

(57) ABSTRACT

A handover method and apparatus, and a communications device, are provided. The handover method includes sending first information to a source node, where the first information includes a first handover indication; or receiving first target information sent by the source node, where the first target information is used by the terminal to access a target node.

### CROSS-REFERENCE TO RELATED APPLICATIONS

This application is a continuation of International Application No. PCT/CN2021/109828, filed on Jul. 30, 2021, which claims priority to Chinese Patent Application No. 202010763645.6, filed on Jul. 31, 2020. The entire contents of each of the above-identified applications are expressly incorporated herein by reference.

### TECHNICAL FIELD

This application relates to the field of communications technologies, and specifically relates to a handover method and apparatus, and a communications device.

### BACKGROUND

In a process of receiving a multicast service (for example, a terminal whose core network state is an idle state), if the terminal moves, a connection needs to be established with a network first (for example, establishing a wireless connection and a core network connection), and then the terminal is handed over to a target node, resulting in a relatively long interruption time of receiving the multicast service and relatively low reliability of receiving the multicast service.

### SUMMARY

Embodiments of this application provide a handover method and apparatus, and a communications device.

According to a first aspect, a handover method is provided. The method is applied to a terminal and includes:

sending first information to a source node, where the first information includes a first handover indication; or

receiving first target information sent by the source node, where the first target information is used by the terminal to access a target node.

According to a second aspect, a handover method is provided. The method is applied to a source node and includes:

receiving first information sent by a terminal, where the first information includes a first handover indication, or the first information includes a first handover indication and second information, and the second information is used to assist a handover; and

performing a first operation according to the first information, where the first operation includes any one of the following:

sending the first handover indication and/or the second information to a target end; and

initiating a handover operation to the target end, where

the target end is a target node or a core network node.

According to a third aspect, a handover method is provided. The method is applied to a source node and includes:

initiating a handover operation to a target end;

receiving second target information sent by the target end; and

sending first target information to a terminal, where

the target end is a target node or a core network node, and the first target information is used by the terminal to access the target node.

According to a fourth aspect, a handover method is provided. The method is applied to a target node and includes:

receiving second information sent by a source node, where the second information is used to assist a handover; and

performing a second operation, where the second operation includes any one of the following:

sending the second information to a core network function; and

sending second target information to the source node according to the second information, where the second target information is used by the source node to send first target information to a terminal, and the first target information is used by the terminal to access the target node.

According to a fifth aspect, a handover method is provided. The method is applied to a core network function and includes:

receiving fourth information sent by a source node, where the fourth information includes at least one of a first handover indication and second information, and the second information is used to assist a handover; and

performing a third operation according to the fourth information, where the third operation includes at least one of the following:

in a case that the fourth information includes the first handover indication, based on the first handover indication, sending a second handover indication to the source node or sending a handover request to a target node; and

in a case that the fourth information includes the second information, based on the second information, sending the second handover indication to the source node or sending the handover request to the target node.

According to a sixth aspect, a handover apparatus is provided. The handover apparatus is applied to a terminal and includes:

a transceiver module, configured to perform any one of the following:

sending first information to a source node, where the first information includes a first handover indication; or

receiving first target information sent by the source node, where the first target information is used by the terminal to access a target node.

According to a seventh aspect, a handover apparatus is provided. The handover apparatus is applied to a source node and includes:

a second receiving module, configured to receive first information sent by a terminal, where the first information includes a first handover indication, or the first information includes a first handover indication and second information, and the second information is used to assist a handover; and

a first operation module, configured to perform a first operation according to the first information, where the first operation includes any one of the following:

sending the first handover indication and/or the second information to a target end; and

initiating a handover operation to the target end, where

the target end is a target node or a core network node.

According to an eighth aspect, a handover apparatus is provided. The handover apparatus is applied to a source node and includes:

a third operation module, configured to initiate a handover operation to a target end;

a fifth receiving module, configured to receive second target information sent by the target end; and

a second sending module, configured to send first target information to a terminal, where

the target end is a target node or a core network node, and the first target information is used by the terminal to access the target node.

According to a ninth aspect, a handover apparatus is provided. The handover apparatus is applied to a target node and includes:

a sixth receiving module, configured to receive second information sent by a source node, where the second information is used to assist a handover; and

a fourth operation module, configured to perform a second operation, where the second operation includes any one of the following:

sending the second information to a core network function; and

sending second target information to the source node according to the second information, where the second target information is used by the source node to send first target information to a terminal, and the first target information is used by the terminal to access the target node.

According to a tenth aspect, a handover apparatus is provided. The handover apparatus is applied to core network function and includes:

a seventh receiving module, configured to receive fourth information sent by a source node, where the fourth information includes at least one of a first handover indication and second information, and the second information is used to assist a handover; and

a fifth operation module, configured to perform a third operation according to the fourth information, where the third operation includes at least one of the following:

in a case that the fourth information includes the first handover indication, based on the first handover indication, sending a second handover indication to the source node or sending a handover request to a target node; and

in a case that the fourth information includes the second information, based on the second information, sending the second handover indication to the source node or sending the handover request to the target node.

According to an eleventh aspect, a communications device is provided. The communications device includes a processor, a memory, and a program or an instruction that is stored in the memory and that can be run on the processor, where the program or the instruction is executed by the processor to implement the steps of the method in any one of the first aspect to the fifth aspect.

According to a twelfth aspect, a readable storage medium is provided. The readable storage medium stores a program or an instruction, and the program or the instruction is executed by a processor to implement the steps of the method in any one of the first aspect to the fifth aspect.

According to a thirteenth aspect, a chip is provided. The chip includes a processor and a communications interface, the communications interface is coupled to the processor, and the processor is configured to run a program or an instruction of a network-side device to implement the steps of the method in any one of the first aspect to the fifth aspect.

According to a fourteenth aspect, a computer software product is provided. The computer software product is stored in a non-volatile storage medium, and the software product is configured to be executed by at least one processor to implement the steps of the method in any one of the first aspect to the fifth aspect.

According to a fifteenth aspect, a communications device is provided. The communications device is configured to perform the method according to any one of the first aspect to the fifth aspect.

### BRIEF DESCRIPTION OF DRAWINGS

FIG. 1 is a block diagram of a wireless communications system according to some implementations of the present disclosure;

FIG. 2 is a first flowchart of a handover method according to some implementations of the present disclosure;

FIG. 3 is a second flowchart of a handover method according to some implementations of the present disclosure;

FIG. 4 is a third flowchart of a handover method according to some implementations of the present disclosure;

FIG. 5 is a fourth flowchart of a handover according to some implementations of the present disclosure;

FIG. 6 is a fifth flowchart of a handover method according to some implementations of the present disclosure;

FIG. 7a is a sixth flowchart of a handover method according to some implementations of the present disclosure;

FIG. 7b is a seventh flowchart of a handover method according to some implementations of the present disclosure;

FIG. 7c is an eighth flowchart of a handover method according to some implementations of the present disclosure;

FIG. 7d is a ninth flowchart of a handover method according to some implementations of the present disclosure;

FIG. 7e is a tenth flowchart of a handover method according to some implementations of the present disclosure;

FIG. 7f is an eleventh flowchart of a handover method according to some implementations of the present disclosure;

FIG. 8a is a twelfth flowchart of a handover method according to some implementations of the present disclosure;

FIG. 8b is a thirteenth flowchart of a handover method according to some implementations of the present disclosure;

FIG. 8c is a fourteenth flowchart of a handover method according to some implementations of the present disclosure;

FIG. 8d is a fifteenth flowchart of a handover method according to some implementations of the present disclosure;

FIG. 8e is a sixteenth flowchart of a handover method according to some implementations of the present disclosure;

FIG. 8f is a seventeenth flowchart of a handover method according to some implementations of the present disclosure;

FIG. 9a is an eighteenth flowchart of a handover method according to some implementations of the present disclosure;

FIG. 9b is a nineteenth flowchart of a handover method according to some implementations of the present disclosure;

FIG. 9c is a twentieth flowchart of a handover method according to some implementations of the present disclosure;

FIG. 9d is a twenty-first flowchart of a handover method according to some implementations of the present disclosure;

FIG. 10 is a first structural diagram of a handover apparatus according to some implementations of the present disclosure;

FIG. 11 is a second structural diagram of a handover apparatus according to some implementations of the present disclosure;

FIG. 12 is a third structural diagram of a handover apparatus according to some implementations of the present disclosure;

FIG. 13 is a fourth structural diagram of a handover apparatus according to some implementations of the present disclosure;

FIG. 14 is a fifth structural diagram of a handover apparatus according to some implementations of the present disclosure;

FIG. 15 is a first structural diagram of a communications device according to some implementations of the present disclosure; and

FIG. 16 is a second structural diagram of a communications device according to some implementations of the present disclosure.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first,” “second,” and the like are intended to distinguish between similar objects but do not describe a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, the following descriptions describe a New Radio (NR) system for example purposes, and NR terms are used in most of the following descriptions, although these technologies can also be applied to an application other than an NR system application, for example, a 6th generation (6G) communications system.

FIG. 1 is a block diagram of a wireless communications system to which embodiments of this application can be applied. The wireless communications system includes a terminal 11, a source node 12, a target node 13, and a Core Network (CN) function 14.

The terminal 11 may also be referred to as a terminal device or User Equipment (UE). The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device, a Vehicle User Equipment (VUE), or a Pedestrian User Equipment (PUE). The wearable device includes a bracelet, a headset, glasses, and the like. It should be noted that a specific type of the terminal 11 is not limited in the embodiments of this application.

The source node 12 and the target node 13 may be a base station, and the base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a Wireless Local Area Network (WLAN) access point, a wireless fidelity (Wi-Fi) node, a Transmitting Receiving Point (TRP), or another suitable term in the art, provided that a same technical effect is achieved. The base station is not limited to a specific technical term.

The core network function 14 may be a Network Function (NF), but is not limited thereto.

In a Long Term Evolution (LTE) system, a Multimedia Broadcast Multicast Service (MBMS) service may be sent in two manners: an MBMS Single-Frequency Network (MBSFN) and a Single-Cell Point-To-Multipoint (SC-PTM) manner.

(1) The MBSFN manner: A plurality of cells in a same MBSFN area simultaneously send a same multicast service, which is equivalent to receiving same data by on a plurality of paths on a user equipment (User Equipment, UE, also referred to as a terminal) side. Both control information (e.g., a control channel parameter, a service channel parameter, and/or scheduling information) and data information of an MBMS service are sent in a broadcast manner, so that both UE in an idle state (idle) and UE in a connected state can receive the MBMS service, and the data information of the MBMS is sent only in an MBSFN subframe. Control information related to the multicast service is sent by using system information (for example, a SIB 13) and a Multicast Control Channel (MCCH), and data is sent by using a Multicast Traffic CHannel (MTCH).

(2) The SC-PTM manner: Information is sent by using a Physical Downlink Shared CHannel (PDSCH) scheduled by a Physical Downlink Control CHannel (PDCCH). Control information is sent by using system information (for example, a SIB 20) and a Single Cell Multicast Control Channel (SC-MCCH), and data is sent by using a Single Cell Multicast Traffic CHannel (SC-MTCH). The SC-MCCH is sent by using a PDSCH scheduled by a Single Cell Radio Network Temporary Identity (SC-RNTI) PDCCH, and the SC-MTCH is sent by using a PDSCH scheduled by a Group RNTI (G-RNTI) PDCCH.

In the embodiments of this application, the multicast service may be the foregoing MBMS, but is not limited thereto.

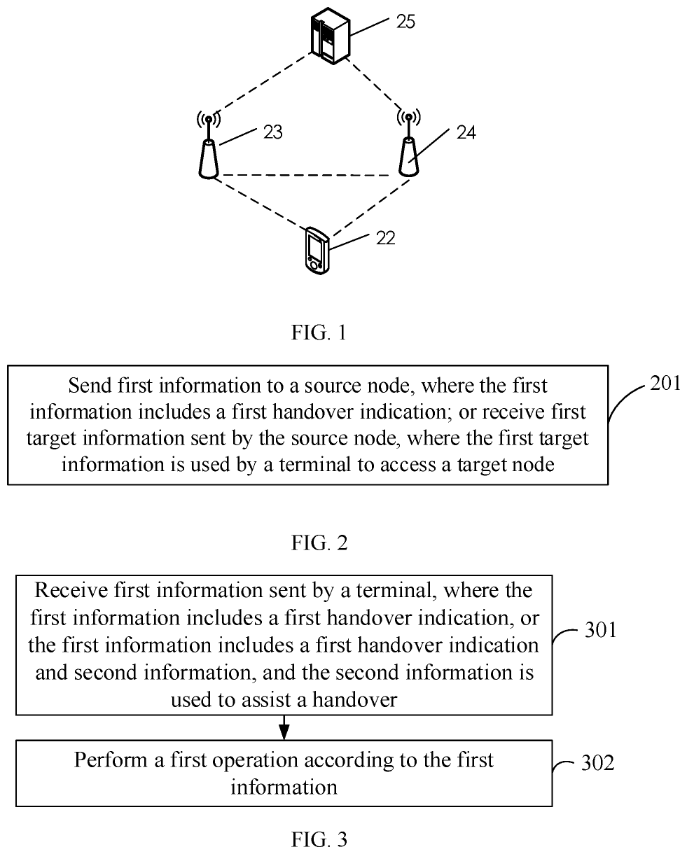

Referring to FIG. 2, FIG. 2 is a first flowchart of a handover method according to an embodiment of this application. The handover method shown in FIG. 2 may be applied to a terminal. In some implementations, the method may be applied to a terminal whose new radio connection is in a connected state and whose core network management state is in an idle state.

As shown in FIG. 2, the handover method applied to the terminal may include the following steps.

Step 201: Send first information to a source node, where the first information includes a first handover indication; or receive first target information sent by the source node, where the first target information is used by the terminal to access a target node.

Details are as follows:

(1) The first information is sent to the source node, where the first information includes the first handover indication.

In this case, the terminal actively sends, to the source node, the first information that includes at least the first handover indication, and triggers a handover procedure.

In some implementations, the terminal may send the first information to the source node during movement, or may send the first information to the source node in a receiving state of a multicast service in a case that the terminal moves. It should be noted that in this embodiment of this application, a trigger condition for the terminal to send the first information to the source node is not limited.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

That is, in this embodiment of this application, the first handover indication may be a handover indication on which no security processing is performed, or may be a handover indication on which security processing is performed. In some implementations, in a case that the first handover indication is the second handover indication, the first handover indication is a handover indication on which no security processing is performed; and the first handover indication is generated based on the second handover indication and the security information, where the first handover indication is a handover indication on which security processing is performed.

In some implementations, the second handover indication may instruct, in an implicit or explicit indication manner, to perform a handover of the terminal, so as to access the terminal to the target node. Details are as follows:

In a case that the second handover indication includes the measurement report, the second handover indication may implicitly instruct, by using the measurement report, to perform the handover of the terminal. In this case, the source node may select the target node according to the measurement report.

In a case that the second handover indication includes the candidate cell information, the second handover indication implicitly instructs, by using the candidate cell information, to perform the handover of the terminal. In this case, the source node may select the target node according to a candidate cell identified by the candidate cell information.

In a case that the second handover indication includes the handover indication information, the second handover indication explicitly instructs, by using the handover indication information, to perform the handover of the terminal. In this case, the source node may blindly select the target node. If the second handover indication further includes the measurement report, the source node may select the target cell according to the measurement report.

In a case that the second handover indication includes the message type information, the second handover indication may implicitly instruct, by using the message type information, to perform the handover of the terminal. For example, if it is assumed that a target message type specified in a protocol implicitly indicates that the handover of the terminal needs to be performed, in a case that a message type setting (for example, setting by using a cause parameter) of a message carrying the second handover indication is the target message type, it implicitly indicates that the handover indication is carried. In this case, the source node may blindly select the target node. If the second handover indication further includes the measurement report, the source node may select the target cell according to the measurement report.

It should be noted that, in an example, the terminal sends the first information to the source node, where the first information includes the first handover indication. The source node may send the first target information, where the first target information is used by the terminal to access the target node. In this case, the terminal triggers the handover and completes the handover.

In another example, the terminal sends the first information to the source node, where the first information includes the first handover indication. The source node does not send the first target information, where the first target information is used by the terminal to access the target node. In this case, the terminal triggers the handover but the handover fails. This case may be applicable to a scenario in which a network side fails to verify the terminal. For example, the network side fails to verify the terminal (for example, it is verified that the terminal is an invalid user), and the network side does not perform the handover process, and therefore does not send the first target information to the terminal, where the target information is used by the terminal to access the target node. Certainly, a scenario in which the terminal triggers the handover but the network side does not initiate the handover is not limited to a scenario in which the verification on the terminal fails.

(2) The first target information sent by the source node is received, where the first target information is used by the terminal to access the target node.

In this case, when receiving the first target information, the terminal may access the target node based on the first target information.

In some implementations, the first target information meets any one of the following:

the first target information is second target information; and

the first target information is generated based on the second target information and security information.

That is, in this embodiment of this application, the first target information may be the second target information on which no security processing is performed, or may be the second target information on which security processing is performed. In some implementations, in a case that the first target information is the second target information, the first target information is the second target information on which no security processing is performed; and the first target information is generated based on the second target information and the security information, where the first target information is the second target information on which security processing is performed.

In an example, the first target information may be generated by the source node based on the second target information and a security parameter. For example, in an N2 handover or Xn handover scenario, the source base station receives the second target information from the core network or the target node, generates the first target information based on the second target information and a group security parameter, and sends the first target information to the terminal.

In another example, the core network node may generate the first target information based on the second target information and a security parameter, and after receiving the first target information, the source node sends the first target information to the terminal. For example, in an N2 handover scenario, after receiving the second target information from the target node, the core network generates the first target information based on the second target information and the NAS security parameter, and sends the first target information to the source node. After receiving the first target information, the source node sends the first target information to the terminal.

In some implementations, target information (for example, the first target information or the second target information) may be a handover command, but is not limited thereto. For example, the target information may be redirection indication information, for example, the terminal is handed over to the target node based on the redirection indication information.

The following describes the security information in this embodiment of this application.

The security information may be any security information that may be used to perform security processing on the second handover indication. This may be determined according to an actual situation, and is not limited in this embodiment of this application.

In some implementations, the security information may be any one of the following: a Non-Access Stratum (NAS) security parameter; a shared key between the terminal and the source node; and a public key of a network-side. The shared key is generated based on information other than a key of the terminal.

In some implementations, the security information may be generated based on any one of the following: a NAS security parameter; a shared key between the terminal and the source node; and a public key of a network-side. The shared key is generated based on information other than a key of the terminal.

It should be noted that, that the shared key is not generated based on the key of the terminal may be understood as: the shared key is not generated based on the key of the terminal.

For the first handover indication or the first target information that is generated based on the security information, a de-secure operation needs to be performed on the first handover indication or the first target information, to obtain the second handover indication or the second target information.

It should be noted that the de-secure operation may be a decryption operation, or may be an integrity verification operation, which is not limited thereto. In the following descriptions, the foregoing understanding may be used for the de-secure operation, and details are not described again.

In some implementations, the de-secure operation on the first handover indication may be performed by the source node, the target node, or the core network node.

In some implementations, in a case that the security information is generated based on the NAS security parameter, the de-secure operation on the first handover indication may be performed by the source node or the core network function. In an example, the first handover indication may be directly sent by the source node to the core network node, and the core network node performs de-secure processing (for example, decryption or integrity verification). In another example, the first handover indication may be sent to the core network node by using the target node, and the core network node performs de-secure processing (for example, decryption). In another example, de-secure processing on the first handover indication may be indicated by the source node. For example, the source node and the terminal obtain the NAS security parameter from the core network side. When the second information is generated based on the NAS security parameter, the source node may perform a de-secure operation on the second information based on the obtained NAS security parameter.

In a case that the security information is generated based on the shared key between the terminal and the source node, de-secure processing on the first handover indication may be performed by the source node.

In a case that the security information is generated based on the public key of a network-side, the de-secure operation on the first handover indication may be performed by the source node, the target node, or the core network node.

A de-secure operation on the first target information may be performed by the terminal. After performing the de-secure operation on the first target information, the terminal may access the target node based on the first target information on which de-secure processing is performed, so that a probability of performing a handover operation due to mistaken receiving of the first target information can be reduced, and access reliability can be further improved.

In the handover method in this embodiment of this application, a terminal actively sends, to a source node, first information that includes at least a first handover indication, and triggers a handover procedure. In this way, before performing a handover operation, the terminal does not need to establish a network connection (for example, a core network connection), so that interruption duration of service reception can be reduced, and reliability of service reception can be improved. In addition, the terminal may access a target node based on first target information on which de-secure processing is performed, so as to reduce a probability of performing a handover operation due to mistaken receiving of the first target information, thereby improving access reliability.

It should be noted that, in an example, the terminal sends the first information to the source node, where the first information includes the first handover indication. The source node may send the first target information, where the first target information is used by the terminal to access the target node. In this case, the terminal triggers the handover and completes the handover.

In another example, the terminal does not send the first information to the source node, where the first information includes the first handover indication. But the source node sends the first target information to the terminal, where the first target information is used by the terminal to access the target node. In this case, the network side triggers the handover and completes the handover. This case may be applicable to a handover scenario triggered by the network side for load control. For example, the network side sends the first target information to the terminal for load control, where the first target information is used by the terminal to access the target node. Certainly, a scenario in which the terminal does not send a handover indication but the network side initiates the handover is not limited to a scenario in which the network side performs load control.

In some implementations, the first information further includes second information, and the second information is used to assist a handover.

In some implementations, the second information may be information used to check or verify an identity of the terminal. For example, the identity of the terminal may be verified according to the second information. In a case that the verification on the identity of the terminal succeeds, that is, in a case that the terminal is a valid terminal and a valid user, the terminal is handed over, thereby further improving handover reliability.

In an implementation in which the first information further includes the second information, the terminal sends the first handover indication and the second information to the source node. In this case, in some implementations, when the terminal is verified based on the second information and a verification result is that the verification succeeds, the network-side node (for example, the source node) may consider that the first handover indication sent by the terminal is valid; otherwise, may consider that the first handover indication sent by the terminal is invalid.

In some implementations, the second information is generated based on one of the following:

a non-access stratum NAS security parameter; and

a shared key between the terminal and a network-side node, where the shared key is generated based on information other than a key of the terminal.

In some implementations, an operation of verifying the terminal based on the second information may be performed by the source node, the core network function, or the target node.

In some implementations, in a case that the second information is generated based on the NAS security parameter, the verification operation on the identity of the terminal may be performed by the source node or the core network function. In an example, the second information may be directly sent by the source node to the core network node, and the core network node performs de-secure processing (for example, decryption). In another example, the second information may be sent to the core network node by using the target node, and the core network node performs de-secure processing (for example, decryption). In another example, de-secure processing on the second information may be performed by the source node. For example, the source node and the terminal obtain the NAS security parameter from the core network side. When the second information is generated based on the NAS security parameter, the source node may perform a de-secure operation on the second information based on the obtained NAS security parameter.

In a case in which the second information is generated based on the shared key between the terminal and the network-side node, the verification operation on the identity of the terminal may be performed by the source node, the target node, or the core network function.

In some implementations, the first information is Access Stratum (AS) information, or the first information is NAS information.

In a case that the first information includes the first handover indication and the second information, in some implementations, the first handover indication is AS information, or the first handover indication is NAS information; and the second information is AS information, or the second information is NAS information. It can be understood that, in this optional implementation, information types of the first handover indication and the second information may be the same or different.

In this embodiment of this application, after the terminal sends the first information to the source node, in some implementations, the method may further include:

receiving the first target information sent by the source node, where the first target information is used to instruct the terminal to access the target node.

It should be noted that for the first target information, refer to the foregoing descriptions. To avoid repetition, details are not described herein again.

Referring to FIG. 3, FIG. 3 is a second flowchart of a handover method according to an embodiment of this application. The handover method shown in FIG. 3 is applied to a source node.

As shown in FIG. 3, the handover method applied to the source node may include the following steps.

Step 301: Receive first information sent by a terminal, where the first information includes a first handover indication, or the first information includes a first handover indication and second information, and the second information is used to assist a handover.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

In some implementations, the security information is any one of the following:

a NAS security parameter;

a shared key between the terminal and the source node, where the shared key is generated based on information other than a key of the terminal; and

a public key of a network-side.

In some implementations, the second information is generated based on one of the following:

a NAS security parameter; and

a shared key between the terminal and a network-side node, where the shared key is generated based on information other than a key of the terminal.

It should be noted that the first information in this embodiment is the same as the first information in the method embodiment in FIG. 2. For details, refer to the foregoing descriptions. Details are not described herein again.

Step 302: Perform a first operation according to the first information.

The first operation includes any one of the following:

sending the first handover indication and/or the second information to a target end; and

initiating a handover operation to the target end, where

The target end is a target node or a core network node.

Details are as follows:

Case 1: The first operation includes sending the first handover indication and/or the second information to the target end.

For example, when the first information includes the first handover indication, if the first handover indication information is generated based on the NAS security parameter, the source node may send the first handover indication to the core network node. When the first information includes the first handover indication and the second information, if the first handover indication information and the second information are generated based on the NAS security parameter, the source node may send the first handover indication to the core network node. If the first handover indication is generated based on the shared key between the terminal and the source node, and the second information is generated based on the NAS security parameter, the source node may directly send the second information to the core network node, or may select the target node and send the second information to the core network node by using the selected target node. If the first handover indication is generated based on the NAS security parameter, and the second information is generated based on the shared key between the terminal and the source node, the source node may send the first handover indication to the core network node.

In case 1, the source node sends the first handover indication and/or the second information to the target end, so that the target end is requested to perform a de-secure operation on the first handover indication and/or perform a verification operation on an identity of the terminal based on the second information, to receive the second handover indication sent by the core network function, and initiate the handover operation to the target end. Therefore, in some implementations, the method may further include:

receiving a second handover indication sent by a core network function; and

initiating the handover operation to the target end, where

the second handover indication is obtained by the core network function based on the received first handover indication or the second information.

In some implementations, that the source node initiates the handover operation to the target end after receiving the second handover indication sent by the core network function may be any one of the following:

(a) sending a handover notification to the core network function, such as sending a handover required message; and

(b) sending a handover request to the target node, for example, sending a handover request message.

In specific implementation, (a) may be applicable to a scenario in which the source node cannot directly communicate with the target node, for example, an N2 handover scenario; and (b) may be applicable to a scenario in which the source node can directly communicate with the target node, for example, an Xn handover scenario.

For example, the first information includes the first handover indication and the second information, where the first handover indication is generated based on the shared key between the terminal and the network-side node, and the second information is generated based on the NAS security parameter. In this case, the source node may send the second information to the core network node. If a handover indication (for example, the second handover indication) sent by the core network node is received, the handover operation is initiated to the target node or the network node.

For example, the first information includes the first handover indication and the second information, where the first handover indication is generated based on the shared key between the terminal and the network-side node, and the second information is generated based on the NAS security parameter. In this case, the source node may send the second information to the core network node. If the second handover indication sent by the core network node is received, the handover operation is initiated to the target node or the network node.

For example, the first information includes the first handover indication and the second information, where the first handover indication is generated based on the shared key between the terminal and the network-side node, and the second information is generated based on the NAS security parameter. In this case, the source node selects the target node and sends the second information to the core network node by using the selected target node. If the second target information sent by the target node is received, the source node considers that the selected target node accepts the handover request, and generates the first target information based on the second target information. The target information is used by the terminal to access the target node.

Case 2: The first operation includes initiating the handover operation to the target end.

In case 2, in a first implementation, after receiving the first information, the source node may perform a de-secure operation on the first handover indication and/or perform a verification operation on an identity of the terminal based on the second information, and initiate the handover operation to the target end. In a second implementation, the initiating the handover operation to the target end may be: sending a handover notification to the core network function, where the handover notification includes at least one of the first handover indication and the second information.

In some implementations, the performing a first operation according to the first information may include:

verifying the terminal based on third information; and

initiating the handover operation to the target end based on a verification result, where

the third information is generated based on the second information, or the third information is generated based on the first handover indication and the second information.

In some implementations, the third information further includes one of the following: a NAS security parameter; a shared key between the terminal and a network-side node, where the shared key is generated based on information other than a key of the terminal; and a public key of a network-side.

In the first implementation, that the source node initiates the handover operation to the target end based on the verification result may be: in a case that the verification result is that the verification succeeds, that is, in a case that the terminal is a valid terminal, the source node initiates the handover operation to the target end, for example, (a) sending a handover notification to the core network function; and (b) sending a handover request to the target node. For details, refer to the foregoing descriptions. Details are not described herein again.

For example, the first information includes the first handover indication and the second information, and the first handover indication and the second information are generated based on the shared key between the terminal and the network-side node. In this case, the source node may verify the terminal, and initiate the handover operation to the target end based on the verification result. For example, if the terminal is verified as a valid terminal, the handover operation is initiated to the target node or a network-side device; or if the terminal is verified as an invalid terminal, no handover operation is initiated.

In comparison with case 1, after receiving the first information, the source node in the first implementation may directly initiate the handover operation to the target end, and does not need to interact with another network-side device. Therefore, handover duration can be shortened, and reliability of receiving service data can be further improved.

In the second implementation, after receiving the first handover indication, the source node may directly send a handover notification including the first handover indication and the second information to the core network function, to request the core network function to initiate the handover operation and send a handover request to the target node. In this way, after receiving the handover notification, the core network function may obtain the second handover indication, and send the handover request to the target node, to connect the terminal to the target node. It can be learned that, in comparison with case 1 and the first implementation, in the second implementation, signaling interaction in the handover process can be further reduced, so that handover duration can be further shortened.

In some implementations, after the performing a first operation according to the first information, the method further includes:

receiving second target information sent by the target end; and

sending first target information to the terminal, where

the first target information is used by the terminal to access the target node.

In some implementations, the first target information meets any one of the following:

the first target information is the second target information; and

the first target information is generated based on the second target information and security information.

In some implementations, the security information is any one of the following:

a non-access stratum NAS security parameter; and

a shared key between the terminal and the source node, where the shared key is generated based on information other than a key of the terminal; and

a public key of a network-side.

It should be noted that for the first target information, refer to the foregoing descriptions. Details are not described herein again.

In some implementations, in a scenario in which the source node may directly communicate with the target node, the target end may be the target node, and the second target information may be a handover response (for example, a handover response message). In a scenario in which the source base station cannot directly communicate with the target node, the target end may be the core network function, and the second target information may be the handover notification.

To facilitate understanding of the handover method in this embodiment, specific description is as follows:

Scenario 1: The first information includes only the first handover indication, where the first handover indication is the second handover indication.

Scenario 2: The first information includes only the first handover indication, where the first handover indication is generated based on the second handover indication and the security information.

Scenario 3: The first information includes the first handover indication and the second information, where the first handover indication is the second handover indication.

Scenario 4: The first information includes the first handover indication and the second information, where the first handover indication is generated based on the second handover indication and the security information.

In scenario 1 and scenario 2, the first information does not include the second information. Therefore, the identity of the terminal does not need to be verified. The following implementations may be included:

In implementation 1, the initiating a handover operation to the target end includes:

initiating the handover operation to the target end according to the second handover indication, where

the handover operation includes any one of the following:

sending a first handover notification to the core network function; and

sending a handover request to the target node.

In implementation 1, after obtaining the second handover indication according to the first handover indication, the source node may directly initiate the handover operation to the target end according to the second handover indication.

The target end is a core network function or a target node.

For example, the first information includes the first handover indication, and the first handover indication is the second handover indication, that is, security processing is not performed on the first handover indication. In this case, the source node may directly initiate the handover operation to the target end.

For example, the first information includes the first handover indication, the first handover indication is generated based on the second handover indication and the security information, and the security information is at least one of the following:

(1) a shared key between the terminal and the source node, where the shared key is generated based on information other than a key of the terminal; and

(2) a public key of a network-side.

In this case, the source base station performs de-secure processing on the first handover indication based on the security information, and may directly initiate the handover operation to the target node.

For example, the first information includes the first handover indication, the first handover indication is generated based on the second handover indication and the security information, and the security information is the NAS security parameter. In this case, the source node sends the first handover indication to the core network-side device, and receives the second handover indication sent by the core network device based on the first handover indication. The source node directly initiates the handover operation to the target end based on the received second handover indication.

In some implementations, in a case that the source node can directly communicate with the target node, the target end may be the target node, and the source node may initiate the handover operation to the target node. The initiating a handover operation to the target end may include: sending a handover request to the target node.

In a case that the source node cannot directly communicate with the target node, the target end may be the core network function, and the source node may initiate the handover operation to the core network function. The initiating a handover operation to the target end may include: sending a handover notification to the core network function.

A difference between scenario 1 and scenario 2 lies in that security processing is not performed on the first handover indication in scenario 1, and security processing is performed on the first handover indication in scenario 2. Therefore, in scenario 1, after receiving the first handover indication, the source node obtains the second handover indication. In scenario 2, the second handover indication can be obtained only after de-secure processing (for example, decryption) is performed on the first handover indication.

It can be learned from the foregoing content that, the de-secure operation on the first handover indication may be performed by the source node, the target node, or the core network node.

In a case that the de-secure operation on the first handover indication is performed by the source node, in some implementations, before the initiating the handover operation to the target end according to the second handover indication, the method further includes: performing de-secure processing on the first handover indication to obtain the second handover indication. In some implementations, the source node obtains the second handover indication by performing de-secure processing on the first handover indication.

In a case that de-secure operation on the first handover indication is performed by the target node or the core network node, in some implementations, after the receiving first information sent by a terminal and before the initiating the handover operation to the target end according to the second handover indication, the method further includes: sending the first handover indication to the target end; and receiving the second handover indication sent by the target end. In some implementations, the source node obtains the second handover indication through receiving.

It should be noted that the target end to which the first handover indication is sent may be the same as or different from the target end to which the handover operation is initiated. For example, the source node may send, to the core network node, the first handover indication on which security processing is performed, and after receiving the second handover indication on which de-secure processing is performed by the core network node, the handover notification may be sent to the core network function.

In implementation 2, the initiating a handover operation to the target end includes: sending a second handover notification to the core network function, where the second handover notification includes the first handover indication.

In comparison with implementation 1, after receiving the first handover indication, the source node needs to first obtain the second handover indication, and then initiates the handover operation to the target end according to the second handover indication. In implementation 2, after receiving the first handover indication, the source node may directly send the second handover notification including the first handover indication to the core network function, and after receiving the second handover notification, the core network function may obtain the second handover indication, and send a handover request to the target node, to connect the terminal to the target node. In this way, in comparison with the foregoing implementation 1, handover duration can be shortened, so that reliability of receiving a multicast service can be further improved.

In implementation 2, if the first handover indication included in the second handover notification is the first handover indication on which security processing is performed, the core network function may obtain the second handover indication by performing de-secure processing on the first handover indication.

In scenario 3 and scenario 4, the first information includes the second information. Therefore, the identity of the terminal needs to be verified. The following implementations may be included:

In implementation 3, the initiating a handover operation to the target end includes:

initiating the handover operation to the target end according to the second handover indication, where

the handover operation includes any one of the following:

sending a first handover notification to the core network function; and

sending a handover request to the target node.

For example, the first information includes the first handover indication and the second information, and the first handover indication is the second handover indication, that is, security processing is not performed on the first handover indication. If the second information is generated based on the NAS security parameter, the source node may send the second information to the core network node. When receiving the handover indication of the core network node, the handover operation is initiated to the target end (for example, the target node) based on the first handover indication.

For example, the first information includes the first handover indication and the second information, and the first handover indication is the second handover indication, that is, security processing is not performed on the first handover indication. If the second information is generated based on the shared key between the terminal and the network-side node, the source node may verify the terminal based on the shared key between the terminal and the network-side node. If the terminal is verified as a valid terminal, the handover operation is initiated to the target end (for example, the target node). If the terminal is verified as an invalid terminal, no handover operation is initiated.

For example, the first information includes the first handover indication and the second information, the first handover indication is generated based on the second handover indication and the security information, and the security information is one of the following:

(1) a shared key between the terminal and the source node, where the shared key is generated based on information other than a key of the terminal; and

(2) a public key of a network-side.

The second information is generated based on the shared key between the terminal and the network-side node.

In this case, the source node performs de-secure processing on the first handover indication information, and verifies the terminal based on the second information. If the terminal is verified as a valid terminal, the handover operation is initiated to the target end (for example, the target node). If the terminal is verified as an invalid terminal, no handover operation is initiated.

For example, the first information includes the first handover indication and the second information, the first handover indication is generated based on the second handover indication and the security information, and the security information is the NAS security parameter.

The second information is generated based on the shared key between the terminal and the network-side node.

In this case, the source node sends the first handover indication to the core network node. If the second handover indication sent by the core network is received, and the terminal is verified as a valid terminal based on the second information, the handover operation is initiated to the target end (for example, the target node). If the terminal is verified as an invalid terminal, no handover operation is initiated.

For example, the first information includes the first handover indication and the second information, the first handover indication is generated based on the second handover indication and the security information, and the security information is the NAS security parameter.

The second information is generated based on the NAS security parameter.

In this case, the source node sends the first handover indication and the second information to the core network node. If the second handover indication sent by the core network is received, the handover operation is initiated to the target end (for example, the target node). If the terminal is verified as an invalid terminal, no handover operation is initiated.

For example, the first information includes the first handover indication and the second information, the first handover indication is generated based on the second handover indication and the security information, and the security information is one of the following:

(1) a shared key between the terminal and the source node, where the shared key is generated based on information other than a key of the terminal; and

(2) a public key of a network-side.

The second information is generated based on the NAS security parameter.

In this case, the source node sends the second information to the core network node. In addition, the source node performs de-secure processing on the first handover indication. If the second handover indication sent by the core network is received, the handover operation is initiated to the target end (for example, the target node) based on the second handover indication.

It should be noted that an implementation principle of implementation 3 is the same as an implementation principle of the foregoing implementation 1. For details, refer to the foregoing descriptions. Details are not described herein again.

A difference between scenarios 3 and 4 and scenarios 1 and 2 lies in that the identity of the terminal needs to be verified based on scenarios 1 and 2. It can be learned from the foregoing content that, the verification operation on the terminal may be performed by the source node, the core network function, or the target node.

In a case that the verification operation on the terminal is performed by the source node, in some implementations, after the receiving first information sent by a terminal and before the initiating a handover operation to the target end, the method further includes: verifying the terminal according to the second information to obtain a verification result; and the initiating a handover operation to the target end includes: initiating the handover operation to the target end in a case that the verification result is that the verification succeeds. In this case, after receiving the first information, the source node may verify the identity of the terminal, and may initiate the handover operation to the target end according to the second handover indication in a case that verification on the terminal succeeds.

In a case that the verification operation on the terminal is performed by the core network function or the target node, in some implementations, after the receiving first information sent by a terminal and before the initiating a handover operation to the target end, the method further includes: sending the first information to the target end; and receiving the first handover indication sent by the target end. In this case, after receiving the first information, the source node needs to send the first information to the target end, so that the target end verifies the identity of the terminal, and sends the first handover indication to the source node after verification on the terminal succeeds. Then, the handover operation is initiated to the target end according to the second handover indication.

In implementation 4, the initiating a handover operation to the target end includes:

sending a third handover notification to the core network function, where the third handover notification includes the first handover indication and the second information.

A difference between implementation 4 and implementation 2 lies in that, based on implementation 2, the handover notification sent by the source node to the core network function further includes the second information. In this way, after receiving the handover notification, the core network function may first perform the verification operation on the identity of the terminal based on the second information, and send the handover request to the target node according to the second handover indication in a case that the verification succeeds, to connect the terminal to the target node. In this way, in comparison with implementation 3, handover duration can be shortened, so that reliability of receiving a multicast service can be further improved.

In some implementations, after the source base station initiates the handover operation, after the performing a first operation, the method further includes: sending the target information to the terminal, where the target information is used to instruct the terminal to access the target node; and the target end is the core network function or the target node.

In some implementations, in a scenario in which the source node can directly communicate with the target node, when receiving a handover response sent by the target base station, the source node may directly send the target information to the terminal.

In a scenario in which the source base station cannot directly communicate with the target node, the source node sends the second information to the terminal after receiving the second information sent by the core network function.

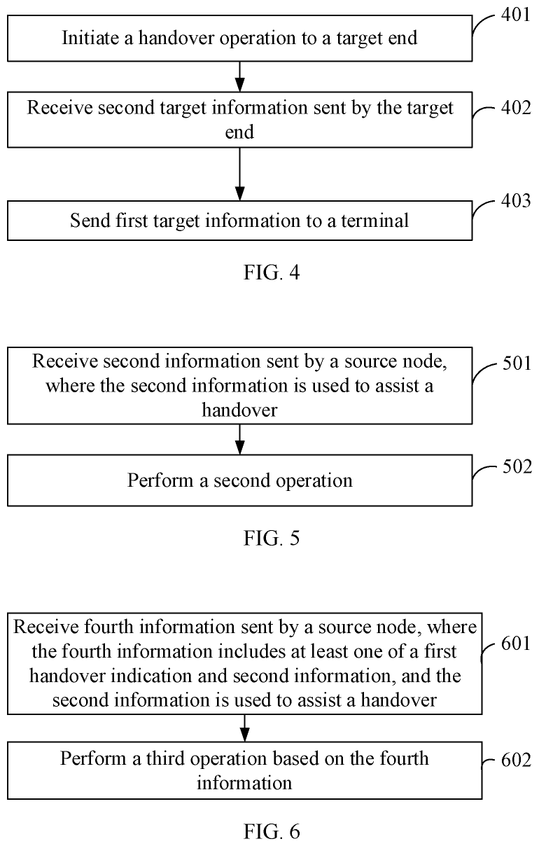

Referring to FIG. 4, FIG. 4 is a third flowchart of a handover method according to an embodiment of this application. The handover method shown in FIG. 4 may be applied to a source node.

As shown in FIG. 4, the handover method applied to the source node may include the following steps.

Step 401: Initiate a handover operation to a target end.

The target end is a target node or a core network node.

In some implementations, the initiating a handover operation to a target end may include any one of the following:

sending a handover notification to a core network function; and

sending a handover request to the target node.

Step 402: Receive second target information sent by the target end.

In some implementations, in a scenario in which the source node may directly communicate with the target node, the target end may be the target node, and the second target information may be a handover response. In a scenario in which the source base station cannot directly communicate with the target node, the target end may be the core network function, and the second target information may be the handover notification.

In an example, the source node may initiate the handover operation to the target end in a case that first information sent by a terminal is not received. This is applicable to an initiated handover scenario in which the source node is in load control. Certainly, the application scenario is not limited thereto.

Step 403: Send first target information to a terminal.

The first target information is used by the terminal to access the target node.

In some implementations, the first target information meets any one of the following:

the first target information is the second target information; and

the first target information is generated based on the second target information and security information.

In some implementations, the security information is any one of the following:

a NAS security parameter;

a shared key between the terminal and the source node, where the shared key is generated based on information other than a key of the terminal; and

a public key of a network-side.

It should be noted that for the first target information, refer to the foregoing descriptions. Details are not described herein again.

In an example, the first target information may be generated by the source node based on the second target information and a security parameter. For example, in an N2 handover or Xn handover scenario, the source base station receives the second target information from the core network or the target node, generates the first target information based on the second target information and the security parameter, and sends the first target information to the terminal. The security parameter may be a NAS security parameter, for example, a NAS security parameter obtained by the source node and the terminal from the core network. The source node generates the first target information based on the obtained security parameter and the second target information, and the terminal performs de-secure processing on the received first target information based on the obtained NAS security parameter. The security parameter may be alternatively a group security parameter, and a manner in which the source node processes the second target information is the same as the manner in which the security parameter is the NAS security parameter. Details are not described herein again.

In another example, the core network node may generate the first target information based on the second target information and a security parameter, and after receiving the first target information, the source node sends the first target information to the terminal. For example, in an N2 handover scenario, after receiving the second target information from the target node, the core network generates the first target information based on the second target information and the NAS security parameter, and sends the first target information to the source node. After receiving the first target information, the source node sends the first target information to the terminal.

In the handover method in this embodiment, a source base station may perform security processing on second target information, so that security of the target information can be improved, thereby improving handover reliability.

Referring to FIG. 5, FIG. 5 is a fourth flowchart of a handover method according to an embodiment of this application. The handover method shown in FIG. 5 may be applied to a target node.

As shown in FIG. 5, the handover method applied to the target node may include the following steps.

Step 501: Receive second information sent by a source node, where the second information is used to assist a handover.

Step 502: Perform a second operation.

The second operation includes any one of the following:

sending the second information to a core network function; and

sending second target information to the source node according to the second information, where the second target information is used by the source node to send first target information to a terminal, and the first target information is used by the terminal to access the target node.

In a case that the second information is sent to the core network function, the second operation is used to request the core network function to perform a verification operation on an identity of the terminal.

In a case that the second operation includes sending the second target information to the source node according to the second information, in some implementations, the performing a second operation includes:

verifying the terminal based on the second information; and

sending the second target information to the source node based on a verification result.

In this case, the target base station performs a verification operation on an identity of the terminal based on the second information, and may send the second target information to the source node when the verification result is that the verification succeeds, so that the source node sends the first target information to the terminal, and the terminal accesses the target node.

In some implementations, the verifying the terminal based on the second information includes:

verifying the terminal based on the second information and any one of the following:

a shared key between the terminal and a network-side node, where the shared key is generated based on information other than a key of the terminal; and

a public key of a network-side.

In the handover method in this embodiment, a target node may forward second information to a core network function to perform a verification operation on an identity of a terminal, or may perform a verification operation on an identity of a terminal based on received second information, thereby improving handover flexibility.

It should be noted that this embodiment is used as the embodiment of the target node corresponding to the method embodiment in FIG. 2, FIG. 3, or FIG. 4. Therefore, reference may be made to the related descriptions in the method embodiment in FIG. 2, FIG. 3, or FIG. 4, and a same beneficial effect can be achieved. To avoid repeated descriptions, details are not described herein again.

Referring to FIG. 6, FIG. 6 is a fifth flowchart of a handover method according to an embodiment of this application. The handover method shown in FIG. 6 may be applied to a core network function.

As shown in FIG. 6, the handover method applied to the core network function may include the following steps.

Step 601: Receive fourth information sent by a source node, where the fourth information includes at least one of a first handover indication and second information, and the second information is used to assist a handover.

It should be noted that for the first handover indication and the second information, refer to the foregoing descriptions. Details are not described herein again.

Step 602: Perform a third operation based on the fourth information.

The third operation includes at least one of the following:

in a case that the fourth information includes the first handover indication, based on the first handover indication, sending a second handover indication to the source node or sending a handover request to a target node; and

in a case that the fourth information includes the second information, based on the second information, sending the second handover indication to the source node or sending the handover request to the target node.

In some implementations, in a case that the fourth information includes the first handover indication, if the first handover indication is carried a handover notification, the core network function may directly send the handover request to the target node based on the first handover indication.

If the first handover indication is carried in a message other than the handover notification, the core network function may send the second handover indication to the source node based on the first handover indication, so that the source node initiates the handover operation based on the second handover indication, for example, sends the handover notification to the core network function; or send the handover request to the target node.

In a case that the fourth information includes the second information, if the second information is carried in a handover notification, the core network function may determine, based on the second information, that the terminal expects to perform the handover operation, so that the handover request can be directly sent to the target node.

If the second information is carried in a message other than the handover notification, the core network function may generate the second handover indication based on the second information, and send the second handover indication to the source node, so that the source node initiates the handover operation based on the second handover indication, for example, sends the handover notification to the core network function; or send the handover request to the target node.

In some implementations, the sending a second handover indication to the source node or sending a handover request to a target node includes:

verifying the fourth information based on a NAS security parameter; and

based on a verification result, sending the second handover indication to the source node or sending the handover request to the target node.

In the handover method in this embodiment, based on received fourth information, a core network function may send a second handover indication to a source node or send a handover request to a target node, thereby improving handover reliability or shortening handover duration.

It should be noted that this embodiment is used as the embodiment of the core network function corresponding to the method embodiment in FIG. 2, FIG. 3, or FIG. 4. Therefore, reference may be made to the related descriptions in the method embodiment in FIG. 2, FIG. 3, or FIG. 4, and a same beneficial effect can be achieved. To avoid repeated descriptions, details are not described herein again.

It should be noted that the plurality of optional implementations described in this embodiment of this application may be implemented in combination with each other, or may be separately implemented. This is not limited in this embodiment of this application.

For ease of understanding, an example is described as follows:

Embodiment 1: in an Xn handover scenario, a measurement report (Measurement Report, MR) is not carried.

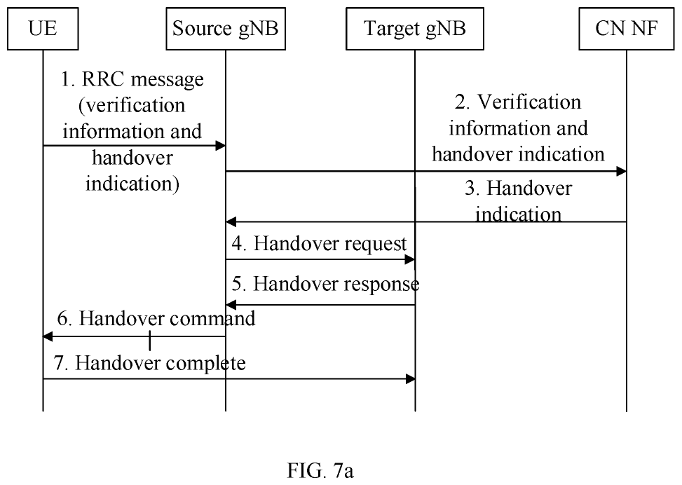

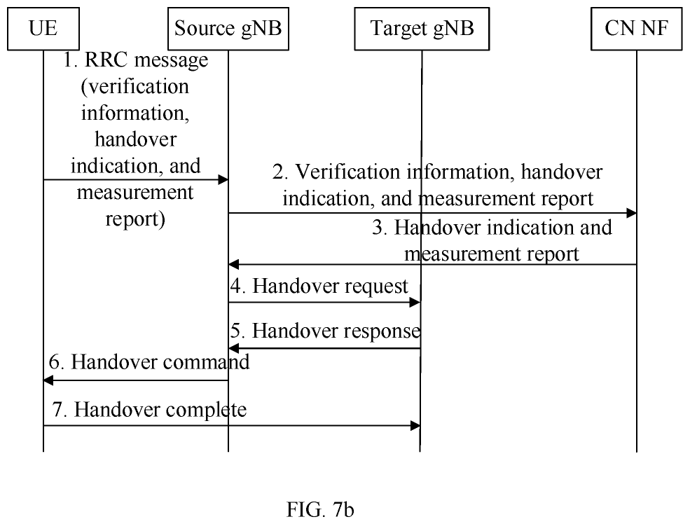

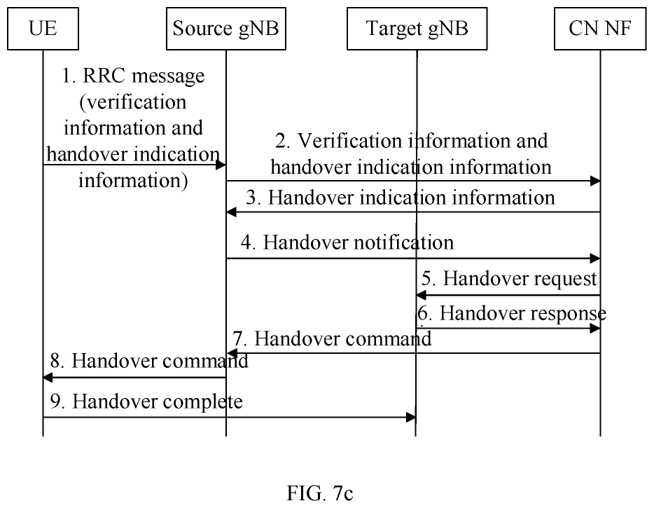

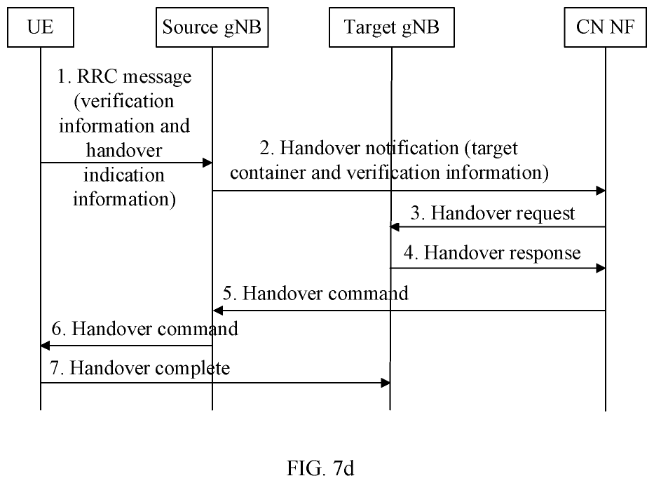

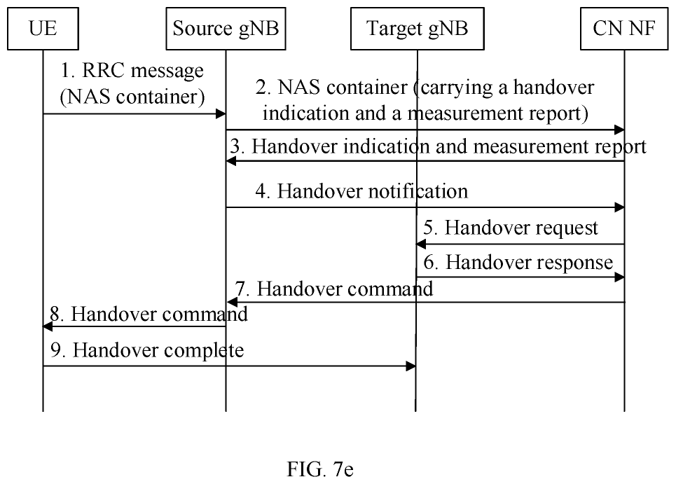

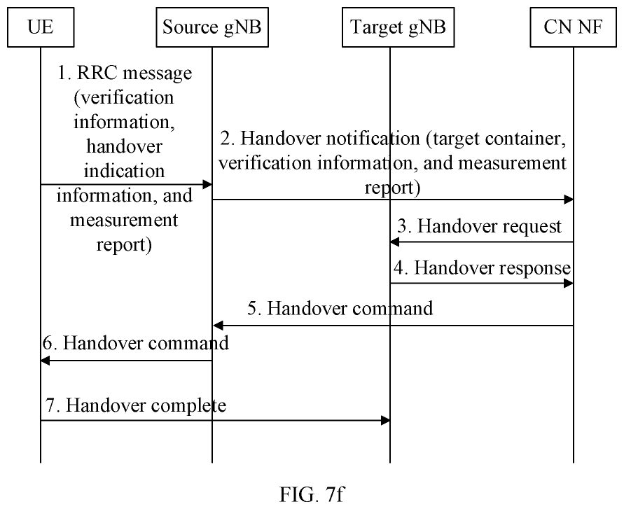

Referring to FIG. 7a, the handover method in Embodiment 1 may include the following steps:

Step 1: UE sends a message to a source base station, where the message carries verification information and handover indication information.

The verification information and the handover indication information may be carried in a Radio Resource Control (RRC) message.

The verification information may be NAS information, and the verification information and the handover indication information may be placed in a container, such as a NAS container.

The handover indication information may be indicated in any one of the following manners:

Being indicated by a message type. For example, a new message type is introduced. When the message type is set as the newly introduced message type, it implicitly indicates that the handover indication information is carried.

Being indicated by a handover parameter. For example, a new handover indication parameter is introduced. When the newly introduced parameter is carried in the NAS container, it explicitly indicates that the handover indication information is carried.

Being indicated by a service type. For example, for a specific service type (for example, an MBMS), when sending the message to a network side due to receiving or sending data of the specific service type, it implicitly indicates that the handover indication information is carried.

Step 2: The source base station receives the message sent by the UE, and sends the verification information and the handover indication information carried in the message to a CN NF.

Step 3: The CN NF receives the message sent by the source base station, verifies the terminal based on the verification information, and sends the handover indication information to the source base station.

The CN NF determines, in any one of the following manners, that the handover indication information is received:

when a message type is set as a newly introduced NAS message type, determining that the handover indication information is received;

when a newly introduced handover parameter is carried, determining that the handover indication information is received; and

when information of a specific service type is carried, determining that the handover indication information is received.

Step 4: The source base station receives the handover indication information, determines, based on the handover indication, to perform a handover operation, selects a target base station, and sends a handover request message to the target base station.

Step 5: The target base station receives the handover request message, and sends a handover response message to the source base station.

Step 6: The source base station sends a handover command to the terminal.

Step 7: The terminal sends a handover complete message to the target base station.

The handover complete information may be an RRC connection complete message.

Embodiment 2: In an Xn handover scenario, an MR is carried.

As shown in FIG. 7b, the handover method in Embodiment 2 may include the following steps.

Step 1: UE sends a message to a source base station, where the message carries verification information, handover indication information, and a measurement report.

The verification information may be NAS information. The verification information, the handover indication information, and the measurement report may be placed in a container (for example, a NAS container). For example, when the terminal has a measurement result, a measurement report is generated based on a latest measurement result, and the measurement report is carried in the NAS container.

The handover indication information may be indicated in any one of the following manners:

Being indicated by a message type. For example, a new message type is introduced. When the message type is set as the newly introduced message type, it implicitly indicates that the handover indication information is carried.

Being indicated by a handover parameter. For example, a new handover indication parameter is introduced. When the newly introduced parameter is carried in the message, it indicates that the handover indication information is carried.

Being indicated by the measurement report. For example, when the message carries the measurement report, it implicitly indicates that the handover indication information is carried.

Being indicated by a service type. For example, for a specific service type (for example, an MBMS), when sending the message to a network side due to receiving or sending data of the specific service type, it implicitly indicates that the handover indication information is carried.

Step 2: The source base station receives the message sent by the UE, and sends the verification information, the handover indication, and the measurement repot carried in the message to a CN NF.

Step 3: The CN NF receives the message sent by the base station, verifies the terminal based on the verification information, and sends the handover indication information and the measurement repot to the source base station.

The CN NF determines, in any one of the following manners, that the handover indication information is received:

when a message type is set as a newly introduced message type, determining that the handover indication information is received;

when a newly introduced handover parameter is carried, determining that the handover indication information is received;

when the measurement report is carried, determining that the handover indication information is received; and

when information of a specific service type is carried, determining that the handover indication information is received.

Step 4: The CN NF sends the handover indication information and the measurement report to the source base station.

The handover indication information may be implicitly indicated by the measurement report. For example, the CN NF may send only the measurement report to the base station, and after receiving the measurement report, the base station determines that there is the handover indication information.

Step 5: The source base station receives the handover indication information and the measurement report, determines, based on the handover indication and the measurement report, to perform a handover operation, selects a target base station, and sends a handover request message (for example, a handover request message) to the target base station.

Step 6: The target base station receives the handover request message, and sends a handover response message (for example, a handover response message) to the source base station.

Step 7: The source base station sends a handover command message to the terminal.

Step 8: The terminal sends a handover complete message to the target base station.

Embodiment 3: In an N2 handover scenario, an MR is not carried.

As shown in FIG. 7c, the handover method in Embodiment 3 may include the following steps.

Steps 1 to 3 are the same as those in Embodiment 1.

Step 4: The source base station receives the handover indication information, determines, based on the handover indication, to perform a handover operation, selects a target base station, and sends a handover notification (for example, a handover required message) to the CN NF.

Step 5: The CN NF receives the handover notification message, and sends a handover request message (for example, a handover request message) to the target base station.

Step 6: The target base station sends a handover response message to the CN NF.

Step 7: The CN NF sends a handover command message to the source base station.

Step 8: The source base station sends the handover command message to the terminal.

Step 9: The terminal sends a handover complete message to the target base station.

As shown in FIG. 7d, the handover method in Embodiment 3 may include the following steps.

Step 1: A terminal UE sends verification information and handover indication information to a source base station.

The verification information may be a NAS message.

Step 2: The source base station receives the message sent by the UE, determines, based on the handover indication carried in the message, to perform a handover operation, selects a target base station, sends a handover notification (for example, a handover required message) to a CN NF, and sends the verification information in the message to the CN NF.

Step 3: The CN NF receives the handover notification message and the verification information, verifies the UE based on the verification information, and sends a handover request message (for example, a handover request message) to the target base station.

Step 4: The target base station sends a handover response message to the CN NF.

Step 5: The CN NF sends a handover command message to the source base station.

Step 6: The source base station sends the handover command message to the terminal.

Step 7: The terminal sends a handover complete message to the target base station.

Embodiment 4: In an N2 handover scenario, an MR is carried.

As shown in FIG. 7e, the handover method in Embodiment 4 may include the following steps.

Steps 1 to 3 are the same as those in Embodiment 2.

Step 4: The source base station receives the handover indication information and the measurement report, determines, based on the handover indication and the measurement report, to perform a handover operation, selects a target base station, and sends a handover notification (for example, a handover required message) to the CN NF.

Step 5: The CN NF receives the handover notification message, and sends a handover request message (for example, a handover request message) to a target base station.

Step 6: The target base station sends a handover response message to the CN NF.

Step 7: The CN NF sends a handover command message to the source base station.

Step 8: The source base station sends the handover command message to the terminal.

Step 9: The terminal sends a handover complete message to the target base station.

As shown in FIG. 7f, the handover method in Embodiment 4 may include the following steps.

Step 1: UE sends verification information, handover indication information, and a measurement report to a source base station.

The verification information may be a NAS message.

Step 2: The source base station receives a message sent by the UE, determines, based on the handover indication and the measurement report carried in the message, to perform a handover operation, selects a target base station, sends a handover notification (for example, a handover required message) to a CN NF, and sends the verification information in the message to the CN NF.

Step 3: The CN NF receives the handover notification message and the verification information, verifies the UE based on the verification information, and sends a handover request message (for example, a handover request message) to the target base station.

Step 4: The target base station sends a handover response message to the CN NF.

Step 5: The CN NF sends a handover command message to the source base station.

Step 6: The source base station sends the handover command message to the terminal.

Step 7: The terminal sends a handover complete message to the target base station.

The handover method in this embodiment of this application may be applicable to 5G and a subsequent evolved communications system.

In this embodiment of this application, a terminal sends information to a network side, where the information carries verification information and handover indication information, and the network node performs a handover based on the verification information and the handover indication. Further, the information sent by the terminal to the network side may further carry a measurement report. The verification information may be a NAS message. The verification information and the handover indication information, or the verification information, the handover indication information, and the measurement report may be placed in a container.

The handover method in this embodiment of this application may further include the following implementations:

### Implementation 1

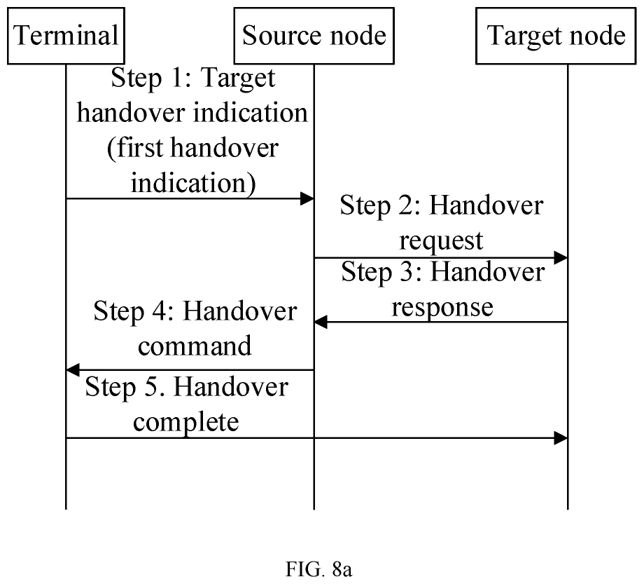

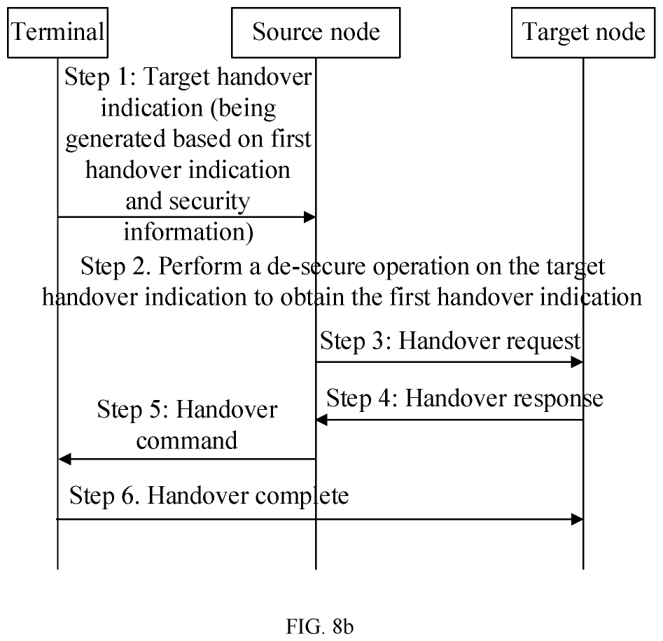

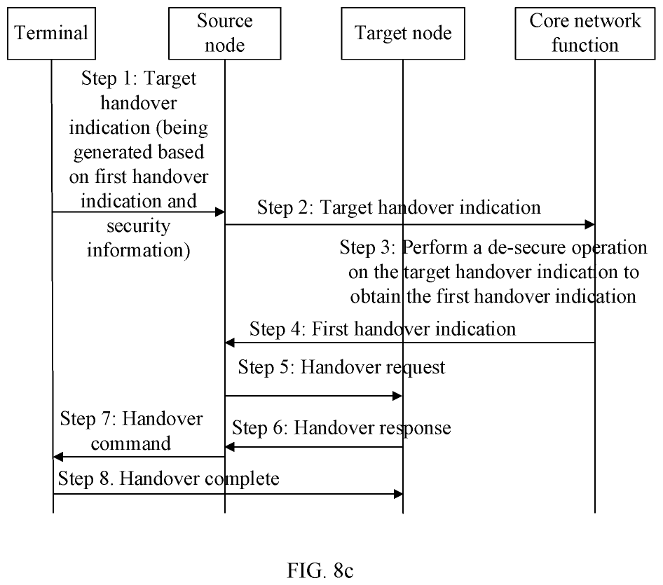

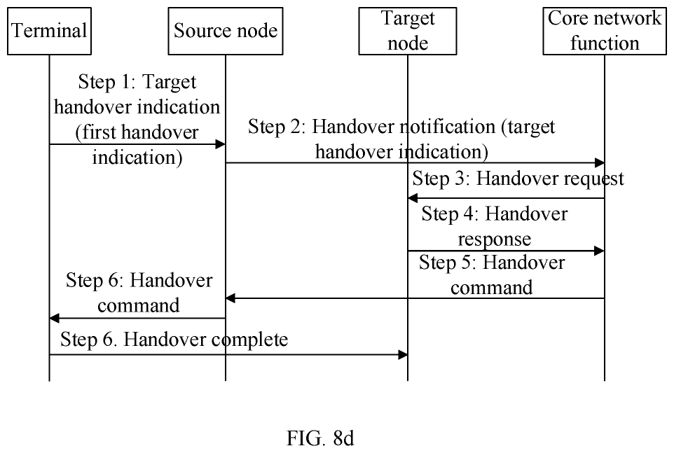

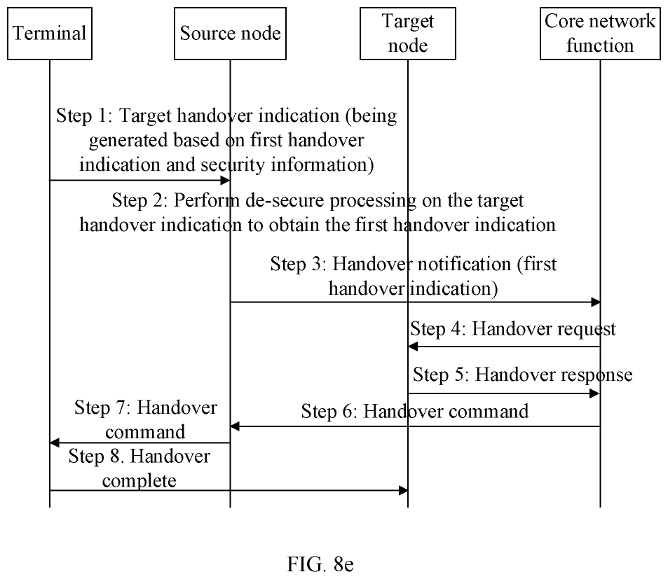

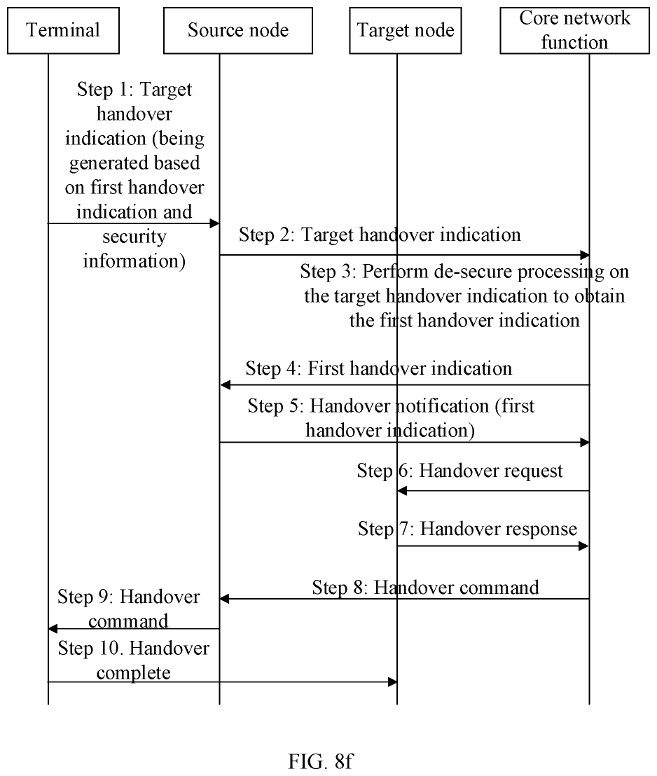

As shown in FIG. 8a, the handover method may include the following steps.

Step 1: A terminal sends a target handover indication to a source node, where the target handover indication is a first handover indication.

Step 2: After receiving the target handover indication, the source node sends a handover request to a target node.

Step 3: The target node sends a handover response to the source node.

Step 4: The source node sends a handover command to the terminal.

Step 5: The terminal sends handover complete to the target node.

### Implementation 2

As shown in FIG. 8b, the handover method may include the following steps.

Step 1: A terminal sends a target handover indication to a source node, where the target handover indication is generated based on a first handover indication and security information.

Step 2: After receiving the target handover indication, the source node performs a de-secure operation on the target handover indication to obtain the first handover indication.

Step 3: The source base station sends a handover request to a target node.

Step 4: The target node sends a handover response to the source node.

Step 5: The source node sends a handover command to the terminal.

Step 6: The terminal sends handover complete to the target node.

### Implementation 3

As shown in FIG. 8c, the handover method may include the following steps.

Step 1: A terminal sends a target handover indication to a source node, where the target handover indication is generated based on a first handover indication and security information.

Step 2: The source node sends the target handover indication to a core network function.

Step 3: After receiving the target handover indication, the core network function performs a de-secure operation on the target handover indication to obtain the first handover indication.

Step 4: The core network function sends the first handover indication to the source node.

Step 5: The source node sends a handover request to a target node.

Step 6: The target node sends a handover response to the source node.

Step 7: The source node sends a handover command to the terminal.

Step 8: The terminal sends handover complete to the target node.

### Implementation 4

As shown in FIG. 8d, the handover method may include the following steps.

Step 1: A terminal sends a target handover indication to a source node, where the target handover indication is a first handover indication.

Step 2: The source node sends the target handover indication to a core network function.

Step 3: After receiving the target handover indication, the core network function sends a handover request to a target node.

Step 4: The target node sends a handover response to the core network function.

Step 5: The core network function sends a handover command to the source node.

Step 6: The source node sends the handover command to the terminal.

Step 7: The terminal sends handover complete to the target node.

### Implementation 5

As shown in FIG. 8e, the handover method may include the following steps.

Step 1: A terminal sends a target handover indication to a source node, where the target handover indication is generated based on a first handover indication and security information.

Step 2: After receiving the target handover indication, the source node performs a de-secure operation on the target handover indication to obtain the first handover indication.

Step 3: The source node sends a handover notification to the core network function, where the handover notification carries the first handover indication.

Step 4: After receiving the handover notification, the core network function sends a handover request to a target node.

Step 5: The target node sends a handover response to the core network function.

Step 6: The core network function sends a handover command to the source node.

Step 7: The source node sends the handover command to the terminal.

Step 8: The terminal sends handover complete to the target node.

### Implementation 6

As shown in FIG. 8f, the handover method may include the following steps.

Step 1: A terminal sends a target handover indication to a source node, where the target handover indication is generated based on a first handover indication and security information.

Step 2: The source node sends the target handover indication to a core network function.

Step 3: After receiving the target handover indication, the core network function performs a de-secure operation on the target handover indication to obtain the first handover indication.

Step 4: The core network function sends the first handover indication to the source node.

Step 5: The source node sends a handover notification to the core network function, where the handover notification carries the first handover indication.

Step 6: After receiving the handover notification, the core network function sends a handover request to a target node.

Step 7: The target node sends a handover response to the core network function.

Step 8: The core network function sends a handover command to the source node.

Step 9: The source node sends the handover command to the terminal.

Step 10: The terminal sends handover complete to the target node.

### Implementation 7

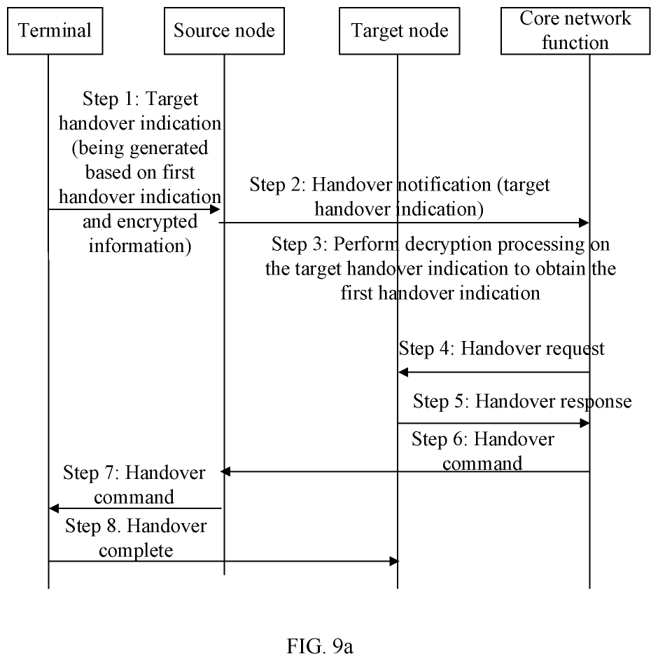

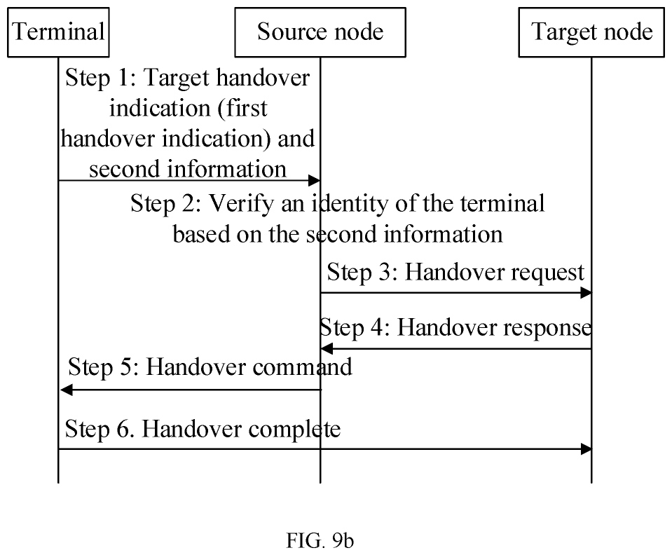

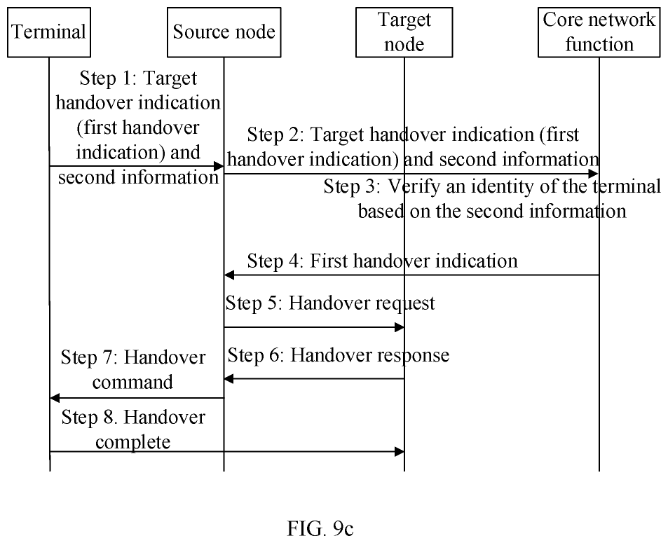

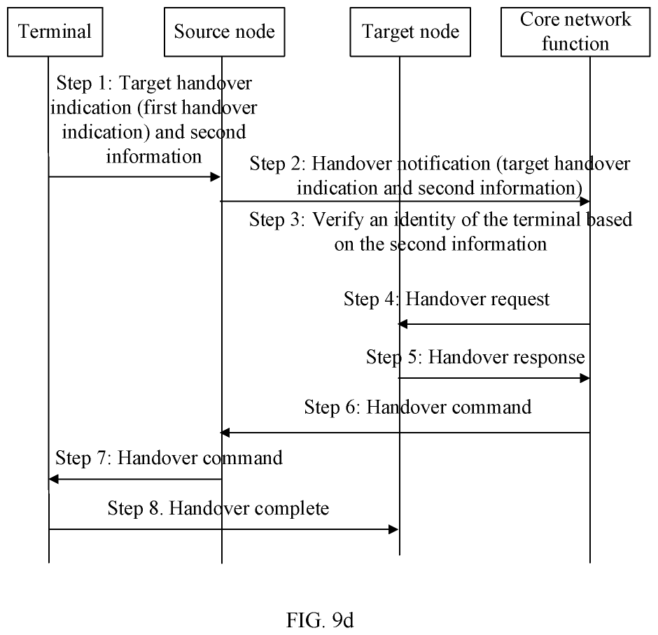

As shown in FIG. 9a, the handover method may include the following steps.

Step 1: A terminal sends a target handover indication to a source node, where the target handover indication is generated based on a first handover indication and security information.

Step 2: The source node sends a handover notification to a core network function, where the handover notification carries the target handover indication.

Step 3: After receiving the handover notification, the core network performs a de-secure operation on the target handover indication to obtain the first handover indication.

Step 4: The core network function sends a handover request to a target node.

Step 5: The target node sends a handover response to the core network function.

Step 6: The core network function sends a handover command to the source node.

Step 7: The source node sends the handover command to the terminal.

Step 8: The terminal sends handover complete to the target node.

### Implementation 8

As shown in FIG. 9b, the handover method may include the following steps.

Step 1: A terminal sends a target handover indication and second information to a source node, where the target handover indication is a first handover indication.

Step 2: After receiving the target handover indication and the second information, the source node verifies an identity of the terminal based on the second information.

Step 3 is performed in a case that the verification succeeds.

Step 3: The source node sends a handover request to a target node.

Step 4: The target node sends a handover response to the source node.

Step 5: The source node sends a handover command to the terminal.

Step 6: The terminal sends handover complete to the target node.

### Implementation 9

As shown in FIG. 9c, the handover method may include the following steps.

Step 1: A terminal sends a target handover indication and second information to a source node, where the target handover indication is a first handover indication.

Step 2: The source node sends the target handover indication and the second information to a core network function.

Step 3: After receiving the target handover indication and the second information, the core network function verifies an identity of the terminal based on the second information.

Step 4 is performed in a case that the verification succeeds.

Step 4: The core network function sends the first handover indication to the source node.

Step 5: The source node sends a handover request to a target node.

Step 6: The target node sends a handover response to the source node.

Step 7: The source node sends a handover command to the terminal.

Step 8: The terminal sends handover complete to the target node.

### Implementation 10

As shown in FIG. 9d, the handover method may include the following steps.

Step 1: A terminal sends a target handover indication and second information to a source node, where the target handover indication is a first handover indication.

Step 2: The source node sends a handover notification to a core network function, where the handover notification includes the target handover indication and the second information.

Step 3: After receiving the handover notification, the core network function verifies an identity of the terminal based on the second information.

Step 4 is performed in a case that the verification succeeds.

Step 4: The core network function sends a handover request to a target node.

Step 5: The target node sends a handover response to the core network function.

Step 6: The core network function sends a handover command to the source node.

Step 7: The source node sends the handover command to the terminal.

Step 8: The terminal sends handover complete to the target node.

It should be noted that the handover method provided in the embodiments of this application may be performed by a handover apparatus, or a control module that is in the handover apparatus and that is configured to perform the handover method. In the embodiments of this application, an example in which the handover apparatus performs the handover method is used to describe the handover apparatus provided in the embodiments of this application.

The handover apparatus in the embodiments of this application may be an apparatus, or may be a component, an integrated circuit, or a chip in a terminal, a source node, a target node, or a core network function. The apparatus may be a mobile terminal, or a non-mobile terminal. For example, the mobile device may include but is not limited to the types of the foregoing listed terminal 11, and the non-mobile terminal may be a server, a Network Attached Storage (NAS), a personal computer, a television, an automated teller machine, or a self-service machine. This is not specifically limited in the embodiments of this application.

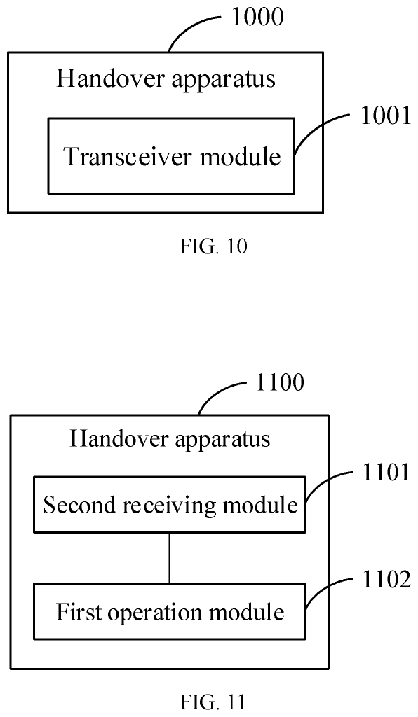

Referring to FIG. 10, FIG. 10 is a first structural diagram of a handover apparatus according to an embodiment of this application. A handover apparatus 1000 includes:

a transceiver module 1001, configured to perform any one of the following:

sending first information to a source node, where the first information includes a first handover indication; or

receiving first target information sent by the source node, where the first target information is used by the terminal to access a target node.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

In some implementations, the first target information meets any one of the following:

the first target information is second target information; and

the first target information is generated based on the second target information and security information.

In some implementations, the security information is any one of the following:

a NAS security parameter;

a shared key between the terminal and the source node, where the shared key is generated based on information other than a key of the terminal; and

a public key of a network-side.

In some implementations, the first information further includes second information, and the second information is used to assist a handover.

In some implementations, the second information is generated based on one of the following:

a NAS security parameter; and

a shared key between the terminal and a network-side node, where the shared key is generated based on information other than a key of the terminal.

In some implementations,

the first information is access stratum AS information, or the first information is NAS information.

In some implementations,

the first handover indication is AS information, or the first handover indication is NAS information; and

the second information is AS information, or the second information is NAS information.

In some implementations, in a case that the transceiver module 1000 is configured to send the first information to the source node, the handover apparatus 1000 further includes:

a first receiving module, configured to receive the first target information sent by the source node, where the first target information is used by the terminal to access the target node.

The handover apparatus 1000 provided in this embodiment of this application may be an apparatus, or may be a component, an integrated circuit, or a chip in a terminal. The terminal may include but is not limited to a type of the foregoing listed terminal 11. The handover apparatus 1000 can implement the processes in the method embodiment in FIG. 2 and achieve a same technical effect. To avoid repetition, details are not described herein again.

Referring to FIG. 11, FIG. 11 is a second structural diagram of a handover apparatus according to an embodiment of this application.

As shown in FIG. 11, a handover apparatus 1100 includes:

a second receiving module 1101, configured to receive first information sent by a terminal, where the first information includes a first handover indication, or the first information includes a first handover indication and second information, and the second information is used to assist a handover; and

a first operation module 1102, configured to perform a first operation according to the first information, where the first operation includes any one of the following:

sending the first handover indication and/or the second information to a target end; and

initiating a handover operation to the target end, where

the target end is a target node or a core network node.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

In some implementations, the handover apparatus further includes:

a third receiving module, configured to receive a second handover indication sent by a core network function; and

a second operation module, configured to initiate the handover operation to the target end, where

the second handover indication is obtained by the core network function based on the received first handover indication or the second information.

In some implementations, in a case that the first operation includes initiating the handover operation to the target end, the first operation module 1102 includes:

a first verification unit, configured to verify the terminal based on third information; and

an operation unit, configured to initiate the handover operation to the target end based on a verification result, where

the third information is generated based on the second information, or the third information is generated based on the first handover indication and the second information.

In some implementations, the third information further includes one of the following:

a NAS security parameter;

a shared key between the terminal and a network-side node, where the shared key is generated based on information other than a key of the terminal; and

a public key of a network-side.

In some implementations, the handover apparatus 1100 further includes:

a fourth receiving module, configured to receive second target information sent by the target end; and

a first sending module, configured to send first target information to the terminal, where

the first target information is used by the terminal to access the target node.

In some implementations, the first target information meets any one of the following:

the first target information is the second target information; and

the first target information is generated based on the second target information and security information.

In some implementations, the security information is any one of the following:

a NAS security parameter;

a shared key between the terminal and the source node, where the shared key is generated based on information other than a key of the terminal; and

a public key of a network-side.

The handover apparatus 1100 provided in this embodiment of this application may be an apparatus, or may be a component, an integrated circuit, or a chip in a source node. The source node may include but is not limited to a type of the foregoing listed source node 12. The handover apparatus 1100 can implement the processes in the method embodiment in FIG. 3 and achieve a same technical effect. To avoid repetition, details are not described herein again.

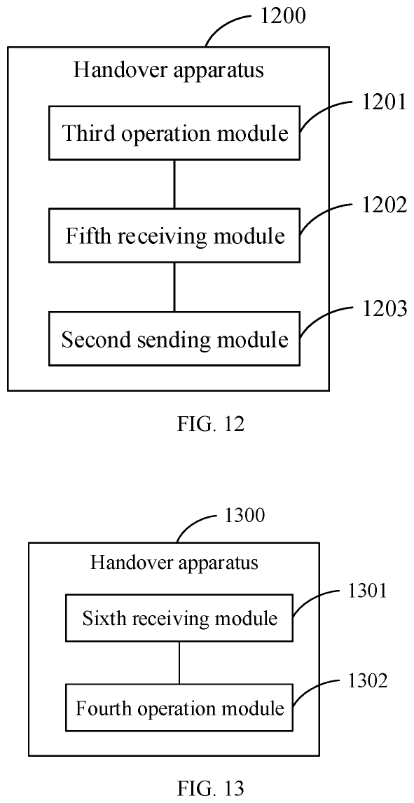

Referring to FIG. 12, FIG. 12 is a third structural diagram of a handover apparatus according to an embodiment of this application.

As shown in FIG. 12, a handover apparatus 1200 includes:

a third operation module 1201, configured to initiate a handover operation to a target end;

a fifth receiving module 1202, configured to receive second target information sent by the target end; and

a second sending module 1203, configured to send first target information to a terminal, where

the target end is a target node or a core network node, and the first target information is used by the terminal to access the target node.

In some implementations, the first target information meets any one of the following:

the first target information is the second target information; and

the first target information is generated based on the second target information and security information.

In some implementations, the security information is any one of the following:

a non-access stratum NAS security parameter;

a shared key between the terminal and the source node, where the shared key is generated based on information other than a key of the terminal; and

a public key of a network-side.

The handover apparatus 1200 provided in this embodiment of this application may be an apparatus, or may be a component, an integrated circuit, or a chip in a source node. The source node may include but is not limited to a type of the foregoing listed source node 12. The handover apparatus 1200 can implement the processes in the method embodiment in FIG. 4 and achieve a same technical effect. To avoid repetition, details are not described herein again.

Referring to FIG. 13, FIG. 13 is a fourth structural diagram of a handover apparatus according to an embodiment of this application.

As shown in FIG. 13, a handover apparatus 1300 includes:

a sixth receiving module 1301, configured to receive second information sent by a source node, where the second information is used to assist a handover; and

a fourth operation module 1302, configured to perform a second operation, where the second operation includes any one of the following:

sending the second information to a core network function; and

sending second target information to the source node according to the second information, where the second target information is used by the source node to send first target information to a terminal, and the first target information is used by the terminal to access the target node.

In some implementations, in a case that the second operation includes sending the second target information to the source node, the fourth operation module 1302 includes:

a second verification unit, configured to verify the terminal based on the second information; and

a first sending unit, configured to send the second target information to the source node based on a verification result.

In some implementations, the second verification unit, is configured to:

verify the terminal based on the second information and any one of the following:

a shared key between the terminal and a network-side node, where the shared key is generated based on information other than a key of the terminal; and

a public key of a network-side.

The handover apparatus 1300 provided in this embodiment of this application may be an apparatus, or may be a component, an integrated circuit, or a chip in a target node. The target node may include but is not limited to a type of the foregoing listed target node 13. The handover apparatus 1300 can implement the processes in the method embodiment in FIG. 5 and achieve a same technical effect. To avoid repetition, details are not described herein again.

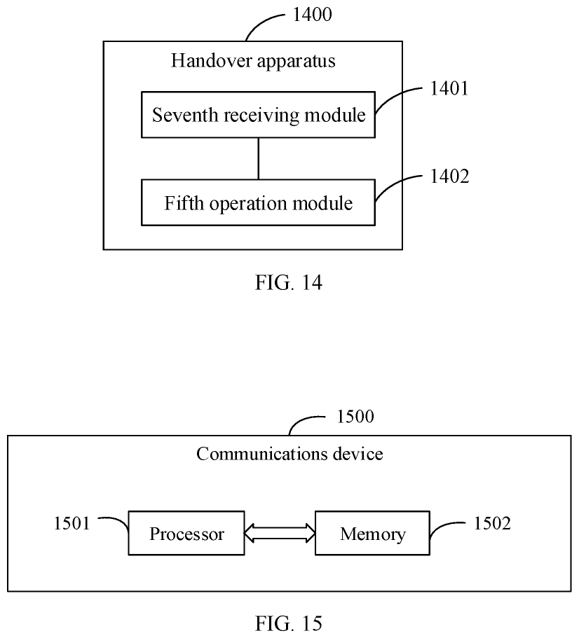

Referring to FIG. 14, FIG. 14 is a fifth structural diagram of a handover apparatus according to an embodiment of this application.

As shown in FIG. 14, a handover apparatus 1400 includes:

a seventh receiving module 1401, configured to receive fourth information sent by a source node, where the fourth information includes at least one of a first handover indication and second information, and the second information is used to assist a handover; and

a fifth operation module 1402, configured to perform a third operation according to the fourth information, where the third operation includes at least one of the following:

in a case that the fourth information includes the first handover indication, based on the first handover indication, sending a second handover indication to the source node or sending a handover request to a target node; and

in a case that the fourth information includes the second information, based on the second information, sending the second handover indication to the source node or sending the handover request to the target node.

In some implementations, the fifth operation module includes:

a third verification unit, configured to verify the fourth information based on a NAS security parameter; and

a second sending unit, configured to: based on a verification result, send the second handover indication to the source node or send the handover request to the target node.

The handover apparatus 1400 provided in this embodiment of this application may be an apparatus, or may be a component, an integrated circuit, or a chip in a core network function. The core network function may include but is not limited to a type of the foregoing listed. The handover apparatus 1400 can implement the processes in the method embodiment in FIG. 6 and achieve a same technical effect. To avoid repetition, details are not described herein again.

In some implementations, as shown in FIG. 15, an embodiment of this application further provides a communications device 1500, including a processor 1501, a memory 1502, and a program or an instruction that is stored in the memory 1502 and that can be run on the processor 1501. For example, when the communications device 1500 is a terminal, the program or the instruction is executed by the processor 1501 to implement the processes in the method embodiment in FIG. 2, and a same technical effect can be achieved. When the communications device 1500 is a source node, the program or the instruction is executed by the processor 1501 to implement the processes in the method embodiment in FIG. 3 or FIG. 4, and a same technical effect can be achieved. When the communications device 1500 is a target node, the program or the instruction is executed by the processor 1501 to implement the processes in the method embodiment in FIG. 5, and a same technical effect can be achieved. When the communications device 1500 is a core network function, the program or the instruction is executed by the processor 1501 to implement the processes in the method embodiment in FIG. 6, and a same technical effect can be achieved. To avoid repetition, details are not described herein again.

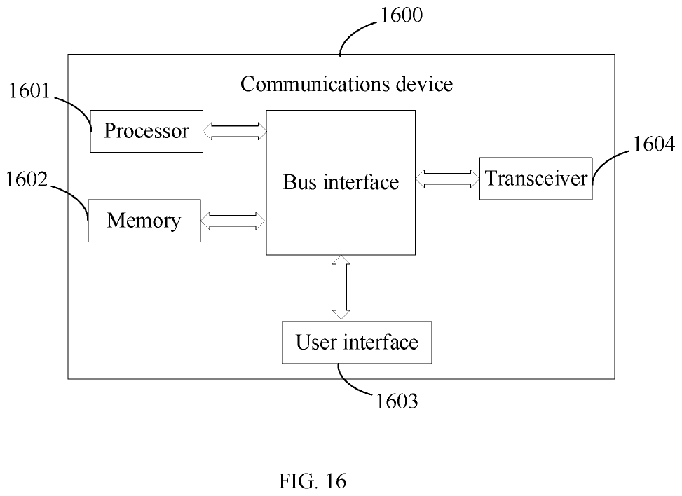

Referring to FIG. 16, FIG. 16 is a second structural diagram of a communications device according to an embodiment of the present disclosure. As shown in FIG. 16, a communications device 1600 includes a processor 1601, a memory 1602, a user interface 1603, a transceiver 1604, and a bus interface.

In this embodiment of the present disclosure, the communications device 1600 further includes a computer program that is stored in the memory 1602 and that can be run on the processor 1601.

I. The communications device 1600 is a terminal.

The computer program is executed by the processor 1601 to implement the following steps:

sending first information to a source node by using the transceiver 1604, where the first information includes a first handover indication; or

receiving, by using the transceiver 1604, first target information sent by the source node, where the first target information is used by the terminal to access a target node.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

In some implementations, the first target information meets any one of the following:

the first target information is second target information; and

the first target information is generated based on the second target information and security information.

In some implementations, the security information is any one of the following:

a NAS security parameter;

a shared key between the terminal and the source node, where the shared key is generated based on information other than a key of the terminal; and

a public key of a network-side.

In some implementations, the first information further includes second information, and the second information is used to assist a handover.

In some implementations, the second information is generated based on one of the following:

a NAS security parameter; and

a shared key between the terminal and the source node, where the shared key is generated based on information other than a key of the terminal.

In some implementations,

the first information is access stratum AS information, or the first information is NAS information.

In some implementations,

the first handover indication is AS information, or the first handover indication is NAS information; and

the second information is AS information, or the second information is NAS information.

In some implementations, the computer program is executed by the processor 1601 to further implement the following step:

receiving, by using the transceiver 1604, the first target information sent by the source node, where the first target information is used by the terminal to access the target node.

In this case, the communications device 1600 can implement the processes implemented by the terminal in the foregoing method embodiment. To avoid repetition, details are not described herein again.

2. The communications device 1600 is a source node.

The computer program is executed by the processor 1601 to implement the following steps:

receiving first information sent by a terminal by using the transceiver 1604, where the first information includes a first handover indication, or the first information includes a first handover indication and second information, and the second information is used to assist a handover; and

performing a first operation according to the first information, where the first operation includes any one of the following:

sending the first handover indication and/or the second information to a target end by using the transceiver 1604; and

initiating a handover operation to the target end by using the transceiver 1604, where

the target end is a target node or a core network node.

In some implementations, the first handover indication meets any one of the following:

the first handover indication is a second handover indication; and

the first handover indication is generated based on the second handover indication and security information, where

the second handover indication includes at least one of the following: a measurement report, candidate cell information, handover indication information, and message type information.

In some implementations, the computer program is executed by the processor 1601 to further implement the following steps:

receiving, by using the transceiver 1604, a second handover indication sent by a core network function; and

initiating the handover operation to the target end by using the transceiver 1604, where

the second handover indication is obtained by the core network function based on the received first handover indication or the second information.

In some implementations, in a case that the first operation includes initiating the handover operation to the target end, the computer program is executed by the processor 1601 to further implement the following steps:

verifying the terminal based on third information; and

initiating the handover operation to the target end based on a verification result by using the transceiver 1604, where

the third information is generated based on the second information, or the third information is generated based on the first handover indication and the second information.

In some implementations, the third information further includes one of the following:

a NAS security parameter;

a shared key between the terminal and a network-side node, where the shared key is generated based on information other than a key of the terminal; and

a public key of a network-side.

In some implementations, the computer program is executed by the processor 1601 to further implement the following steps:

receiving, by using the transceiver 1604, second target information sent by the target end; and

sending first target information to the terminal by using the transceiver 1604, where

the first target information is used by the terminal to access the target node.

In some implementations, the first target information meets any one of the following:

the first target information is the second target information; and

the first target information is generated based on the second target information and security information.

In some implementations, the security information is any one of the following:

a NAS security parameter;

a shared key between the terminal and the source node, where the shared key is generated based on information other than a key of the terminal; and a public key of a network-side.

In this case, the communications device 1600 can implement the processes implemented by the source node in the method embodiment in FIG. 3. To avoid repetition, details are not described herein again.

3. The communications device 1600 is a source node.

The computer program is executed by the processor 1601 to implement the following steps:

initiating a handover operation to a target end by using the transceiver 1604;

receiving, by using the transceiver 1604, second target information sent by the target end; and

sending first target information to a terminal by using the transceiver 1604, where

the target end is a target node or a core network node, and the first target information is used by the terminal to access the target node.

In some implementations, the first target information meets any one of the following:

the first target information is the second target information; and

the first target information is generated based on the second target information and security information.

In some implementations, the security information is any one of the following:

a NAS security parameter;

a shared key between the terminal and the source node, where the shared key is generated based on information other than a key of the terminal; and

a public key of a network-side.

In this case, the communications device 1600 can implement the processes implemented by the source node in the method embodiment in FIG. 4. To avoid repetition, details are not described herein again.

4. The communications device 1600 is a target node.

The computer program is executed by the processor 1601 to implement the following steps:

receiving, by using the transceiver 1604, second information sent by a source node, where the second information is used to assist a handover; and

performing a second operation, where the second operation includes any one of the following:

sending the second information to a core network function by using the transceiver 1604; and

sending second target information to the source node according to the second information by using the transceiver 1604, where the second target information is used by the source node to send first target information to a terminal, and the first target information is used by the terminal to access the target node.

In some implementations, in a case that the second operation includes sending the second target information to the source node, the computer program is executed by the processor 1601 to further implement the following steps:

verifying the terminal based on the second information; and

sending the second target information to the source node based on a verification result by using the transceiver 1604.

In some implementations, the computer program is executed by the processor 1601 to further implement the following step:

verifying the terminal based on the second information and any one of the following:

a shared key between the terminal and a network-side node, where the shared key is generated based on information other than a key of the terminal; and

a public key of a network-side.

In this case, the communications device 1600 can implement the processes implemented by the target node in the foregoing method embodiment. To avoid repetition, details are not described herein again.

5. The communications device 1600 is a core network function.

The computer program is executed by the processor 1601 to implement the following steps:

receiving, by using the transceiver 1604, fourth information sent by a source node, where the fourth information includes at least one of a first handover indication and second information, and the second information is used to assist a handover; and

performing a third operation according to the fourth information, where the third operation includes at least one of the following:

in a case that the fourth information includes the first handover indication, based on the first handover indication by using the transceiver 1604, sending a second handover indication to the source node or sending a handover request to a target node; and

in a case that the fourth information includes the second information, based on the second information by using the transceiver 1604, sending the second handover indication to the source node or sending the handover request to the target node.

In some implementations, the computer program is executed by the processor 1601 to further implement the following steps:

verifying the fourth information based on a NAS security parameter; and

based on a verification result by using the transceiver 1604, sending the second handover indication to the source node or sending the handover request to the target node.

In this case, the communications device 1600 can implement the processes implemented by the core network function in the foregoing method embodiment. To avoid repetition, details are not described herein again.

In FIG. 16, a bus architecture may include any quantity of interconnected buses and bridges. In some implementations, various circuits of one or more processors represented by the processor 1601 and a memory represented by the memory 1602 are interconnected. The bus architecture may further link various other circuits such as a peripheral device, a voltage regulator, and a power management circuit. These are well known in the art, and therefore are not further described in this specification. A bus interface provides an interface. The transceiver 1604 may be a plurality of components. To be specific, the transceiver 1604 includes a transmitter and a receiver, and provides a unit configured to communicate with various other apparatuses on a transmission medium. For different user equipment, a user interface 1603 may be an interface that can externally or internally connect to a needed device, and the connected device includes but is not limited to a keypad, a display, a loudspeaker, a microphone, and a joystick.

The processor 1601 is responsible for bus architecture management and general processing. The memory 1602 may store data used by the processor 1601 when the processor 1601 performs an operation.

An embodiment of the present disclosure further provides a computer-readable storage medium. The computer-readable storage medium stores a computer program, and the computer program is executed by a processor to implement the processes of the method embodiment in FIG. 2, FIG. 3, FIG. 4, FIG. 5, or FIG. 6, and a same technical effect can be achieved. To avoid repetition, details are not described herein again. The computer-readable storage medium includes a Read-only Memory (ROM), a Random Access Memory (RAM), a magnetic disk, or an optical disc.

An embodiment of this application further provides a readable storage medium. The readable storage medium stores a program or an instruction, and the program or the instruction is executed by a processor to implement the processes of the method embodiment in FIG. 2, FIG. 3, FIG. 4, FIG. 5, or FIG. 6, and a same technical effect can be achieved. To avoid repetition, details are not described herein again.

The processor is a processor in the terminal in the foregoing embodiment. The readable storage medium includes a computer-readable storage medium, such as a computer ROM, a RAM, a magnetic disk, or an optical disc.

An embodiment of this application further provides a chip. The chip includes a processor and a communications interface, the communications interface is coupled to the processor, and the processor is configured to run a program or an instruction of a network-side device to implement the processes of the method embodiment in FIG. 2, FIG. 3, FIG. 4, FIG. 5, or FIG. 6, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer software product. The computer software product is stored in a non-volatile storage medium, and the software product is configured to be executed by at least one processor to implement the processes of the method embodiment corresponding to FIG. 2, FIG. 3, FIG. 4, FIG. 5, or FIG. 6, and a same technical effect can be achieved. To avoid repetition, details are not described herein again.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “including a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

A person of ordinary skill in the art may be aware that, in combination with the examples described in the embodiments disclosed in this specification, units and algorithm steps may be implemented by using electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

It can be understood by a person skilled in the art that, for the purpose of convenient and brief description, for a detailed operating process of the foregoing system, apparatus, and unit, refer to a corresponding process in the foregoing method embodiments. Details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions in the embodiments.

In addition, functional units in the embodiments of the present disclosure may be integrated into one processing unit, or each of the units may exist alone physically, or two or more units are integrated into one unit.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

It can be understood that the embodiments described in the embodiments of the present disclosure may be implemented by hardware, software, firmware, middleware, microcode, or a combination thereof. For hardware implementation, a module, a unit, or a subunit may be implemented in one or more Application Specific Integrated Circuits (ASIC), Digital Signal Processor (DSP), DSP Device (DSPD), Programmable Logic Device (PLD), Field-Programmable Gate Array (FPGA), general purpose processors, controllers, microcontrollers, microprocessors, or other electronic units or a combination thereof used to perform the functions in the present disclosure.

For software implementation, the technology in the embodiments of the present disclosure may be implemented through modules (for example, procedures or functions) that perform the functions in the embodiments of the present disclosure. Software code may be stored in a memory and executed by a processor. The memory may be implemented in the processor or outside the processor.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A handover method, performed by a terminal, wherein the method comprises:
sending first information to a source node, wherein the first information comprises a first handover indication; or
receiving first target information sent by the source node, wherein the first target information is used by the terminal to access a target node.

2. The method according to claim 1, wherein the first handover indication meets any one of the following:
the first handover indication is a second handover indication; or
the first handover indication is generated based on the second handover indication and security information, wherein
the second handover indication comprises at least one of the following: a measurement report, candidate cell information, handover indication information, or message type information.

3. The method according to claim 1, wherein the first target information meets any one of the following:
the first target information is second target information; or
the first target information is generated based on the second target information and security information.

4. The method according to claim 2, wherein the security information is any one of the following:
a Non-Access Stratum (NAS) security parameter;
a shared key between the terminal and the source node, wherein the shared key is generated based on information other than a key of the terminal; or
a public key of a network-side.

5. The method according to claim 1, wherein the first information further comprises second information, and the second information is used to assist a handover.

6. The method according to claim 5, wherein the second information is generated based on one of the following:
a Non-Access Stratum (NAS) security parameter; or
a shared key between the terminal and a network-side node, wherein the shared key is generated based on information other than a key of the terminal.

7. The method according to claim 1, wherein after the sending first information to a source node, the method further comprises:
receiving the first target information sent by the source node, wherein the first target information is used by the terminal to access the target node.

8. A handover method, performed by a source node, wherein the method comprises:
receiving first information sent by a terminal, wherein the first information comprises a first handover indication, or the first information comprises a first handover indication and second information, and the second information is used to assist a handover; and
performing a first operation according to the first information, wherein the first operation comprises any one of the following:
sending the first handover indication and/or the second information to a target end; or
initiating a handover operation to the target end, wherein the target end is a target node or a core network node.

9. The method according to claim 8, wherein the first handover indication meets any one of the following:
the first handover indication is a second handover indication; or
the first handover indication is generated based on the second handover indication and security information, wherein
the second handover indication comprises at least one of the following: a measurement report, candidate cell information, handover indication information, or message type information.

10. The method according to claim 8, further comprising:
receiving a second handover indication sent by a core network function; and
initiating the handover operation to the target end, wherein the second handover indication is obtained by the core network function based on the received first handover indication or the second information.

11. The method according to claim 8, wherein in a case that the first operation comprises initiating the handover operation to the target end, the performing a first operation according to the first information comprises:
verifying the terminal based on third information; and
initiating the handover operation to the target end based on a verification result, wherein the third information is generated based on the second information, or the third information is generated based on the first handover indication and the second information.

12. The method according to claim 11, wherein the third information further comprises one of the following:
a Non-Access Stratum (NAS) security parameter;
a shared key between the terminal and a network-side node, wherein the shared key is generated based on information other than a key of the terminal; or
a public key of a network-side.

13. The method according to claim 8, wherein after the performing a first operation according to the first information, the method further comprises:
receiving second target information sent by the target end; and
sending first target information to the terminal, wherein
the first target information is used by the terminal to access the target node.

14. The method according to claim 13, wherein the first target information meets any one of the following:
the first target information is the second target information; or
the first target information is generated based on the second target information and security information.

15. A handover method, performed by a target node, wherein the method comprises:
receiving second information sent by a source node, wherein the second information is used to assist a handover; and
performing a second operation, wherein the second operation comprises any one of the following:
sending the second information to a core network function; or
sending second target information to the source node according to the second information, wherein the second target information is used by the source node to send first target information to a terminal, and the first target information is used by the terminal to access the target node.

16. The method according to claim 15, wherein in a case that the second operation comprises sending the second target information to the source node, the performing a second operation comprises:
verifying the terminal based on the second information; and
sending the second target information to the source node based on a verification result.

17. The method according to claim 16, wherein the verifying the terminal based on the second information comprises:
verifying the terminal based on the second information and any one of the following:
a shared key between the terminal and a network-side node, wherein the shared key is generated based on information other than a key of the terminal; or
a public key of a network-side.

18. A communications device, comprising:
a memory storing computer-readable instructions; and
a processor coupled to the memory and configured to execute the computer-readable instructions, wherein the computer-readable instructions, when executed by the processor, cause the processor to perform the method according to claim 1.

19. A communications device, comprising:
a memory storing computer-readable instructions; and
a processor coupled to the memory and configured to execute the computer-readable instructions, wherein the computer-readable instructions, when executed by the processor, cause the processor to perform the method according to claim 8.

20. A communications device, comprising:
a memory storing computer-readable instructions; and
a processor coupled to the memory and configured to execute the computer-readable instructions, wherein the computer-readable instructions, when executed by the processor, cause the processor to perform the method according to claim 15.
